(19) United States
(12) Patent Application Publication
(10) Pub. No.: US 2018/0253189 A1
(43) Pub. Date: Sep. 6, 2018

(54) CONTROLLING DISPLAY OF CONTENT

(71) Applicant: Google Inc., (US)

(72) Inventors: Sachin Jain, Milpitas, CA (US); Boris Mazniker, San Francisco, CA (US); Sanjay Ghemawat, Mountain View, CA (US); Jonathan Terleski, Mountain View, CA (US); Gregory M. Marra, San Francisco, CA (US)

(73) Assignee: Google Inc., Mountain View, CA (US)

(21) Appl. No.: 13/715,232

(22) Filed: Dec. 14, 2012

Related U.S. Application Data
(60) Provisional application No. 61/576,947, filed on Dec. 16, 2011.

(51) Int. Cl. G06F 3/0481

(52) U.S. Cl. CPC G06F 3/0481

(57) ABSTRACT

A method includes, in one or more processing devices, executing instructions to perform operations that include outputting data for a first graphical user interface comprising a control mechanism for specifying an amount of content from a first content set to include in a second content set. The method also includes receiving, through the control mechanism, information indicative of the amount of content from the first content set to include in the second content set. The method also includes identifying content from the first content set based on a score that is adjusted in accordance with the information, and based on an author of the content being a member of a predefined group of individuals. The method also includes outputting data for a second graphical user interface comprising the second content set the second content set including the identified content.

### CLAIM OF PRIORITY

This application claims priority under 35 USC § 119(e) to U.S. patent application Ser. No. 61/576,947, filed on Dec. 16, 2011, the entire contents of which are hereby incorporated by reference.

### BACKGROUND

This disclosure generally relates to controlling an amount of content for display from selected sources, e.g., in a main content stream of a social network.

Internet-based social networking services provide a digital medium for users to interact with one another and share information. For examples, users are able to distribute digital content (e.g., textual comments, digital images, digital videos, digital audio, hyperlinks to Web sites, etc.) to other users that they might be connected with in the social networking service. Digital content that is distributed to a user can be displayed to the user in a stream page.

As a user's social network within the social networking service increases, the amount of digital content distributed to the user and the amount of digital content that the user interacts with may increase. Consequently, the user's stream page may overwhelm the user with digital content, which can include digital content that might not be relevant to the user and/or digital content that may be of little or no interest to the user.

### SUMMARY

In one aspect, a method includes, in one or more processing devices, executing instructions to perform operations that include outputting data for a first graphical user interface comprising a control mechanism for specifying an amount of content from a first content set to include in a second content set. The method also includes receiving, through the control mechanism, information indicative of the amount of content from the first content set to include in the second content set. The method also includes identifying content from the first content set based on a score that is adjusted in accordance with the information and based on an author of the content being a member of a predefined group of individuals. The method also includes outputting data for a second graphical user interface comprising the second content set the second content set including the identified content. Other aspects can be embodied in corresponding systems and apparatus, including computer program products.

Implementations may also include any or all of the following features. The control mechanism may comprise a slider, the slider being controllable to move between locations corresponding to different amounts of content from the first set. The score may be adjusted in accordance with a value that is based on a location of the slider. The control mechanism may comprise radio buttons, the radio buttons being selectable to correspond to different amounts of content from the first set, wherein the score is adjusted in accordance with a value that is based on which of the radio buttons is selected. The control mechanism may include a drop-down menu, elements of the drop-down menu being selectable to correspond to different amounts of content from the first set, wherein the score is adjusted in accordance with a value that is based on which element of the drop-down menu is selected. The first content set may comprise a first content stream and the second content set may comprise a second content stream, the first content stream comprising content from a first source type and the second content stream comprising content from different source types. The first source type may comprise a group of social contacts and the second source type comprises two or more groups of contacts, the two or more groups of contacts comprises the group of social contacts. The first source type may comprise a contact and the second source type comprises two or more contacts, the two or more contacts comprising the contact. The first content set may comprise at least one of: saved searches and posts, and the second content set may comprise a content stream of a social networking service. The control mechanism may be configured to specify an amount of content from a one or more additional content sets to include in the second content set, the one or more additional content sets being different from the first content set. The control mechanism may specify an amount of content from the first content set by enabling input regarding an affinity for, or interest in content from, an entity associated with the first content set. A portion of the first content set may be provided by an author that is a member of a predefined group of individuals. The first content set may include publicly available content.

In another aspect, a method includes, in one or more processing devices, executing instructions to perform operations that include identifying a content author as a member of a predefined group of individuals, wherein information indicative of the amount of content to be presented in a first content set is provided from a control mechanism associated with the predefined group of individuals. The method also includes determining whether to insert content provided by the content author from the first content set into a second content set based upon information from the control mechanism associated with the predefined group of individuals and based upon scoring the content. The method also includes ordering content inserted into the second content set for presentation in a graphical user interface.

Implementations may also include any or all of the following features. Determining whether to insert content from the content author may include ranking the content. Determining whether to insert content from the content author may include discarding the content based upon the information provided from the control mechanism associated with the predefined group of individuals. Determining whether to insert content from the content author may include inserting the content based upon the information provided from the control mechanism associated with the predefined group of individuals. Determining whether to insert content from the content author may include grouping the content with other content received within a predefined time period. The grouped content may be scored and ranked to identify the content to be inserted into the second content set for presentation in the graphical user interface. Scores assigned to other content from the content author may be modified if the content from the author is inserted into the second content set for presentation in the graphical user interface. The predefined time period may be twenty-four hours. Determining whether to insert content provided by the content author from the first content set into the second content set may be based upon a predefined limit of content entries assigned to the content author. The method may also include retaining previously read content entries in the second content set. Determining whether to insert content provided by the content author from the first content set into the second content set may be based upon the frequency the second content set is viewed in the graphical user interface. Scores assigned to other content from a group that includes the content author may be modified if the content from the author is inserted into the second content set for presentation in the graphical user interface.

In another aspect, an electronic system includes memory to store instructions that are executable, and one or more processing devices to execute the instructions to perform operations that include outputting data for a first graphical user interface comprising a control mechanism for specifying an amount of content from a first content set to include in a second content set. The operations also include receiving, through the control mechanism, information indicative of the amount of content from the first content set to include in the second content set. The operations also include identifying content from the first content set based on a score that is adjusted in accordance with the information, and, outputting data for a second graphical user interface comprising the second content set the second content set including the identified content.

Implementations may also include any or all of the following features. The control mechanism may comprise a slider, the slider being controllable to move between locations corresponding to different amounts of content from the first set. The score may be adjusted in accordance with a value that is based on a location of the slider. The control mechanism may comprise radio buttons, the radio buttons being selectable to correspond to different amounts of content from the first set, wherein the score is adjusted in accordance with a value that is based on which of the radio buttons is selected. The control mechanism may include a drop-down menu, elements of the drop-down menu being selectable to correspond to different amounts of content from the first set, wherein the score is adjusted in accordance with a value that is based on which element of the drop-down menu is selected. The first content set may comprise a first content stream and the second content set may comprise a second content stream, the first content stream comprising content from a first source type and the second content stream comprising content from different source types. The first source type may comprise a group of social contacts and the second source type comprises two or more groups of contacts, the two or more groups of contacts comprises the group of social contacts. The first source type may comprise a contact and the second source type comprises two or more contacts, the two or more contacts comprising the contact. The first content set may comprise at least one of: saved searches and posts, and the second content set may comprise a content stream of a social networking service. The control mechanism may be configured to specify an amount of content from a one or more additional content sets to include in the second content set, the one or more additional content sets being different from the first content set. The control mechanism may specify an amount of content from the first content set by enabling input regarding an affinity for, or interest in content from, an entity associated with the first content set. A portion of the first content set may be provided by an author that is a member of a predefined group of individuals. The first content set may include publicly available content.

In another aspect, an electronic system includes memory to store instructions that are executable, and, one or more processing devices to execute the instructions to perform operations that include identifying a content author as a member of a predefined group of individuals, wherein information indicative of the amount of content to be presented in a first content set is provided from a control mechanism associated with the predefined group of individuals. The operations also include determining whether to insert content provided by the content author from the first content set into a second content set based upon information from the control mechanism associated with the predefined group of individuals, and, ordering content inserted into the second content set for presentation in a graphical user interface.

Implementations may also include any or all of the following features. Determining whether to insert content from the content author may include scoring and ranking the content. Determining whether to insert content from the content author may include discarding the content based upon the information provided from the control mechanism associated with the predefined group of individuals. Determining whether to insert content from the content author may include inserting the content based upon the information provided from the control mechanism associated with the predefined group of individuals. Determining whether to insert content from the content author may include grouping the content with other content received within a predefined time period. The grouped content may be scored and ranked to identify the content to be inserted into the second content set for presentation in the graphical user interface. Scores assigned to other content from the content author may be reduced if the content from the author is inserted into the second content set for presentation in the graphical user interface. The predefined time period may be twenty-four hours. Determining whether to insert content provided by the content author from the first content set into the second content set may be based upon a predefined limit of content entries assigned to the content author. Operations may also include retaining previously read content entries in the second content set. Determining whether to insert content provided by the content author from the first content set into the second content set may be based upon the frequency the second content set is viewed in the graphical user interface. Scores assigned to other content from a group that includes the content author may be reduced if the content from the author is inserted into the second content set for presentation in the graphical user interface.

In another aspect, a computer storage media encoded with one or more computer programs, the one or more computer programs comprising instructions that when executed by data processing apparatus cause the data processing apparatus to perform operations that include outputting data for a first graphical user interface comprising a control mechanism for specifying an amount of content from a first content set to include in a second content set. Operations also include receiving, through the control mechanism, information indicative of the amount of content from the first content set to include in the second content set. Operations also include identifying content from the first content set based on a score that is adjusted in accordance with the information, and, outputting data for a second graphical user interface comprising the second content set the second content set including the identified content.

Implementations may also include any or all of the following features. The control mechanism may comprise a slider, the slider being controllable to move between locations corresponding to different amounts of content from the first set. The score may be adjusted in accordance with a value that is based on a location of the slider. The control mechanism may comprise radio buttons, the radio buttons being selectable to correspond to different amounts of content from the first set, wherein the score is adjusted in accordance with a value that is based on which of the radio buttons is selected. The control mechanism may include a drop-down menu, elements of the drop-down menu being selectable to correspond to different amounts of content from the first set, wherein the score is adjusted in accordance with a value that is based on which element of the drop-down menu is selected. The first content set may comprise a first content stream and the second content set may comprise a second content stream, the first content stream comprising content from a first source type and the second content stream comprising content from different source types. The first source type may comprise a group of social contacts and the second source type comprises two or more groups of contacts, the two or more groups of contacts comprises the group of social contacts. The first source type may comprise a contact and the second source type comprises two or more contacts, the two or more contacts comprising the contact. The first content set may comprise at least one of: saved searches and posts, and the second content set may comprise a content stream of a social networking service. The control mechanism may be configured to specify an amount of content from a one or more additional content sets to include in the second content set, the one or more additional content sets being different from the first content set. The control mechanism may specify an amount of content from the first content set by enabling input regarding an affinity for, or interest in content from, an entity associated with the first content set. A portion of the first content set may be provided by an author that is a member of a predefined group of individuals. The first content set may include publicly available content.

In another aspect, a computer storage media encoded with one or more computer programs, the one or more computer programs comprising instructions that when executed by data processing apparatus cause the data processing apparatus to perform operations that includes identifying a content author as a member of a predefined group of individuals, wherein information indicative of the amount of content to be presented in a first content set is provided from a control mechanism associated with the predefined group of individuals. Operations also include determining whether to insert content provided by the content author from the first content set into a second content set based upon information from the control mechanism associated with the predefined group of individuals, and, ordering content inserted into the second content set for presentation in a graphical user interface.

Implementations may also include any or all of the following features. Determining whether to insert content from the content author may include scoring and ranking the content. Determining whether to insert content from the content author may include discarding the content based upon the information provided from the control mechanism associated with the predefined group of individuals. Determining whether to insert content from the content author may include inserting the content based upon the information provided from the control mechanism associated with the predefined group of individuals. Determining whether to insert content from the content author may include grouping the content with other content received within a predefined time period. The grouped content may be scored and ranked to identify the content to be inserted into the second content set for presentation in the graphical user interface. Scores assigned to other content from the content author may be reduced if the content from the author is inserted into the second content set for presentation in the graphical user interface. The predefined time period may be twenty-four hours. Determining whether to insert content provided by the content author from the first content set into the second content set may be based upon a predefined limit of content entries assigned to the content author. Operations may also include retaining previously read content entries in the second content set. Determining whether to insert content provided by the content author from the first content set into the second content set may be based upon the frequency the second content set is viewed in the graphical user interface. Scores assigned to other content from a group that includes the content author may be reduced if the content from the author is inserted into the second content set for presentation in the graphical user interface.

Advantages of the foregoing techniques may include, but are not limited to, allowing the user to control the relative amounts of content from various sources. As a result, the user is able to select content from sources that the user may trust or that the user may find interesting, and to limit content from other sources that may not be as trustworthy or as interesting.

The systems and techniques described herein, or portions thereof, may be implemented as a computer program product that includes instructions that are stored on one or more non-transitory machine-readable storage media, and that are executable on one or more processing devices. The systems and techniques described herein, or portions thereof, may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 is a diagram of an example network architecture.

FIG. 2 is a diagram of an example social network including social circles.

FIG. 3 depicts a screen-shot of example graphical user interface for creating and maintaining social circles.

FIG. 4 depicts a screen-shot of an example stream page for a user of a social networking service.

FIGS. 5 and 7 to 10 depict example Web pages having a content control mechanism.

FIGS. 6 and 11 depict example Web pages shown content in the main stream of a user of the social network.

FIGS. 12 to 15 are example Web pages depicting alternate positioning of the content control mechanism.

FIG. 16 shows, conceptually, an example of a process for selecting content for inclusion in a main stream.

FIG. 17 is a flowchart of an example process for using values to select content from groups for inclusion in a main stream.

FIGS. 18 and 19 show alternate examples of the content control mechanism.

FIG. 20 depicts different content sources for being controlled by a content control mechanism.

FIG. 21 is a flowchart of an example process for using values to select publically available content for inclusion in a main stream.

FIGS. 22 and 23 are flowcharts.

FIG. 24 shows examples of computing devices on which the processes described herein, or portions thereof, may be implemented.

Like reference symbols in the various drawings indicate like elements.

### DETAILED DESCRIPTION

Described herein are processes for controlling amounts of content included a user's main content stream (or simply, “main stream”) from one or more sources. By way of example, a control mechanism (e.g., a slider) may be associated with a content set (e.g., a page of content from a social circle). The user may select the amount of content to be included from the content set in the main stream by adjusting the control mechanism. In response to this adjustment, information indicating adjustment of the control mechanism is sent to a processing system, which selects, from the content set, appropriate content items for inclusion in the main stream. This information is transmitted to the user's computing device, which renders a Web page containing those content items in the main stream.

The processes presented herein are described in the context of a social networking service; however, they have applicability in other contexts. In this regard, relationships among members of a social networking service are based, at least in part, on social affinities between the members. A social affinity between a particular user of the social networking service and other users of the social networking service can be determined based on a social graph of the particular user. In some examples, a social graph can refer to a single social graph or multiple interconnected social graphs. Distinct social graphs can be generated for different types of connections a user has. For example, a user can be connected with chat contacts in one social graph, electronic messaging contacts in a second social graph, and connections (or contacts) from a particular social networking service in a third social graph. The social graphs can include edges to additional individuals or entities at higher degrees of separation from the user. These contacts can in turn have additional contacts at another degree of separation from the user. Similarly, a user's connection to someone in a particular social network can then be used to identify additional connections based on that person's connections. The distinct social graphs can include edges connecting one or more social graph to one or more other social graphs.

Types of connections and social graphs can include, but are not limited to other users in which the user is in direct contact (e.g., user messaging or chat contact, direct contacts on social sites) and users in which the user is in indirect contact (e.g., friends of friends, connections of users that have a direct connection to the user). In some implementations, the social graph includes content generated by individuals (e.g., blog posts, reviews) as connections to the user. The social graph can include connections within a single network or across multiple networks (separable or integrated). Public social graph relationships can also be considered. In some examples, public relationships can be established through public profiles and/or public social networking services.

A social affinity score can be determined for a connection between one user and another user. The social affinity score can reflect the strength of a relationship between the users. By way of non-limiting example, a first user can be connected to a second user and a third user. The first user and the second user can be in frequent contact with one another through the social networking service (e.g., often sharing items with one another), electronic messaging and/or chat. A first social affinity score can be provided based on the interaction between the first user and the second user. The first user and the third user might be infrequently in contact with one another. For example, the first user might have received an electronic message from the third user only once in the last several months. A second social affinity score can be provided based on the interaction between the first user and the third user. In this example, the first social affinity score is greater than the second social affinity score, reflecting a closer relationship between the first user and the second user than between the first user and the third user.

For purposes of illustration, an example social networking service will be described. The example social networking service enables users to organize contacts into social circles. It is appreciated, however, that the processes described herein can be used in other types of social networking services and are not limited to social networking services that include social circles or similar groupings.

In this example, social circles are categories to which a user can assign contacts and control the distribution and visibility of social networking posts and/or other digital content distributed using the social networking service. In some implementations, a social circle can be provided as a data set defining a collection of contacts that are associated with one another in a computer-implemented social networking service. Generally, a social circle can be described from the perspective of an individual that is the center of a particular collection of socially interconnected people, or from the aggregate perspective of a collection of socially interconnected people. A social circle can have narrowly defined boundaries (e.g., members of the social circle might be familiar with one another) and permission may be required for a member to join a social circle. A user of the social networking service can define a social circle. The social circle, as a data set defining a collection of contacts, may reflect real-life social connections and/or interactions of the user. In some implementations, a social circle can be defined by a user as a personal representation or grouping of a set of contacts, the contacts may be unaware of the social circle and/or unaware of other members of the social circle. Members of a social circle may be able to control whether to be a member or not be a member of the social circle.

Through the creation and use of social circles, the user can organize and categorize social networking contacts into various different groupings that can be used to control the visibility and access those contacts have to the user's postings, digital pictures, videos, audio files, hyperlinks (e.g., uniform resource indicators, URIs), and/or other content associated with the user's social networking profile. As one example, the user can post an update about a work-related nuance to only a “coworker” circle, and spare other contacts within the social networking service from seeing information that is irrelevant to them.

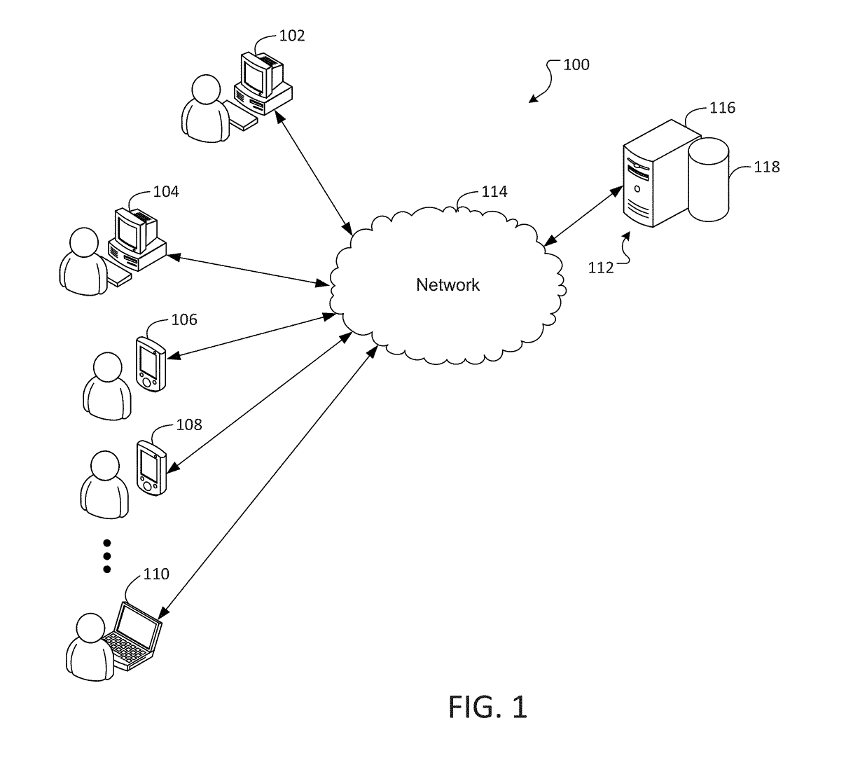

FIG. 1 is a diagram of an example network architecture 100. The network architecture 100 includes a number of client devices 102, 104, 106, 108, 110 communicably connected to a server system 112 by a network 114. The server system 112 includes a processing device 116 and a data store 118. The processing device 116 executes computer instructions (e.g., social network computer program code) stored in the data store 118 to perform the functions of a social network server.

Users of the client devices 102 to 110 access the server device 112 to participate in a social networking service. For example, the client devices 102 to 110 can execute Web browser applications that can be used to access the social networking service. In another example, the client devices 102 to 110 can execute software applications that are specific to the social networking service (e.g., social networking “apps” running on smartphones).

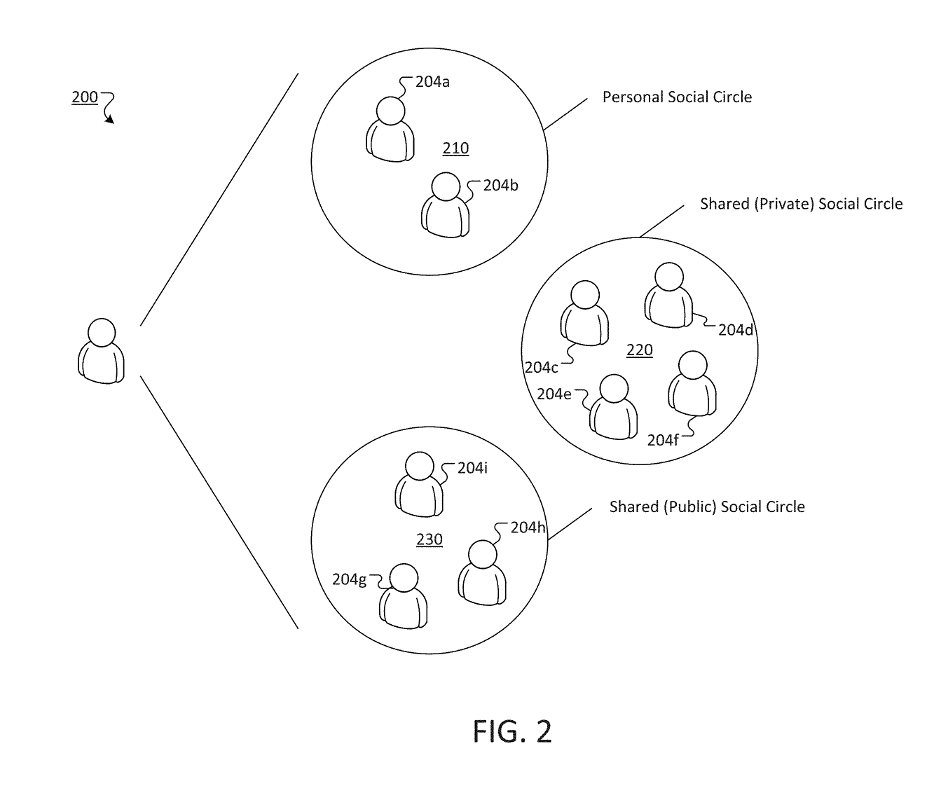

Users interacting with the client devices 102 to 110 can participate in the social networking service provided by the server system 112 through digital content, e.g., text comments (e.g., updates, announcements, replies), digital images, videos, audio files, and/or other appropriate digital content. In some implementations, information can be posted on a user's behalf by systems and/or services external to the social networking service or the server system 112. For example, the user may post a review of a movie to a movie review Web site, and with proper permissions, that Web site may cross-post the review to the social networking service on the user's behalf. In another example, a software application executing on a mobile device, with proper permissions, may use global positioning system (GPS) capabilities to determine the user's location and automatically update the social network with his location (e.g., “At Home”, “At Work”, “In Brownsdale, MN”). Generally, users interacting with the client device 102 to 110 can also use the social networking service provided by the server system 112 to define social circles to organize and categorize the user's relationships to other users of the social networking service. Examples of the creation and use of social circles are provided in the description of FIG. 2 below.

In some implementations, the client devices 102 to 110 can be provided as computing devices, e.g., a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an electronic messaging device, a game console, or a combination of two or more of these data processing devices or other appropriate data processing devices. In some implementations, a computing device may be included as part of a motor vehicle (e.g., an automobile, an emergency vehicle (e.g., fire truck, ambulance), a bus).

In some implementations, the server system 112 can be a single computing device, e.g., a computer server. In some implementations, the server system 112 can represent more than one computing device working together to perform the actions of a server computer (e.g., cloud computing).

Network 114 may include a large computer network, examples of which include a local area network (LAN), wide area network (WAN), the Internet, a cellular network, or a combination thereof connecting a number of mobile computing devices, fixed computing devices, and server systems. The network(s) included in network 114 may provide for communications under various modes or protocols, examples of which include Transmission Control Protocol/Internet Protocol (TCP/IP), Global System for Mobile communication (GSM) voice calls, Short Electronic message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. Communication may occur through a radio-frequency transceiver. In addition, short-range communication may occur, e.g., using a BLUETOOTH, WiFi, or other such transceiver system.

FIG. 2 is a conceptual diagram of an example social network 200 that includes social circles. A user 202 is a member of a social network that supports the creation and use of social circles (e.g., the social network provided by the server device 112 of FIG. 1). In the present example, the user 202 has a number of contacts 204a to 204i with which the user 202 can have some form of relationship (e.g., friends, coworkers, customers, teammates, clients, relatives, club members, classmates, and so forth). The user 202 categorizes the contacts 204a-204i by assigning them to one or more social circles, e.g., Web site a social circle 210, a social circle 220, and a social circle 230.

In this example, social circle 210 is a personal circle. In some implementations, personal circles are groupings created by, and may be known to, the user 202 (e.g., the contacts 204a, 204b may receive no indication that they are in the user's 202 personal social circle 210). In some implementations, personal social circles are groupings created by the user 202 and may be known to the user 202 as well as the contacts (e.g., contacts 204a, 204b) that are members of the social circle (e.g., the contacts 204a, 204b receive an indication that they have been added to the personal social circle 210).

In some implementations, personal circles may be used to organize and categorize the contacts 204a to 204i in ways that are relevant to the user 202. In some implementations, the user 202 may use personal social circles to organize contacts in order to discretely target which of his contacts 204a-204i will see certain postings or have access to particular information. For example, the user 202 may be planning a surprise party for a small group of friends. As such, the user can organize contacts into “Surprise Party Attendees” and “Surprise Party Honorees” personal circles. By doing so, the user 202 may better target selected postings to the friends attending and/or helping to plan the surprise party (i.e., Surprise Party Attendees), while targeting selected postings to friends that are to be honored at the surprise party (i.e., Surprise Party Honorees) to maintain the integrity of the surprise.

The social circle 220 is a shared private circle, which may also be referred to simply as a shared circle. In general, shared private circles are social circles that the user 202 creates and invites contacts to join voluntarily. Contacts that accept the invitation become members of the shared private circle. Members of a shared private circle can see information posted to that circle by the user 202 and can post information to be shared with other members of the shared private circle. For example, the user 202 may tend to post a large number of jokes to the social network. However, while some of the contacts 204a to 204i may find the jokes to be entertaining, others may find them to be simply annoying. Realizing this, the user 202 may create a “jokes” shared private circle and invite some or all of the contacts 204a-204i to join. With the “jokes” social circle in place, the user 202 may post witticisms to the “jokes” circle, and those contacts who have accepted the invitation are able to see the comicality of the user 202. Similarly, members of the shared private circle are able to post messages to the circle, and those posts are visible to other members of that circle.

The social circle 230 is a shared public circle. In general, shared public circles are social circles that the user 202 creates, and invites contacts to join voluntarily. The existence of a shared public circle is publicly available such that other users of the social networking service (e.g., not necessarily just the user's 202 contacts 204a-204i) may request to join the public social circle. Members of shared public circles may post information to, and see updates posted by, other members of the same public shared circle. In some implementations, public shares circles may be “fan” or “group” circles (e.g., circles dedicated to a particular place, event, product, movie, celebrity, sports team, company, concept, philosophy, organization, support network). For example, the user 202 may create a shared public circle for his band, and fans of his act may join the circle to discuss upcoming shows, download MP3s of the band's music, or post videos from recent concerts. In another example, the user 202 may create a shared public circle for alumni of his high school graduating class, which his former classmates may find and join in order to stay in touch with one another and post pictures from their school days. Once a shared public circle is created, in some implementations the user 202 can invite people to join the circle. In some implementations, nonmembers of the circle can request membership in the shared public circle, and membership in a shared public circle may be automatic upon request, or may require the user's 202 approval to become member of the shared public circle.

In some implementations, one or more default social circles can be provided or suggested to a user when the user subscribes to a social networking service. For example, “Friends,” “Family,” and “Coworkers” social circles can automatically be provided in a user's profile upon the user subscribing to the particular social networking service. Other social circles can automatically be provided including, for example, an “Acquaintances” social circle and/or a “Just Following” social circle. In some implementations, the automatically created or suggested social circles can include personal social circles. Although default social circles can be automatically provided, it may be left to the user to actually populate the default social circles with contacts. For example, each of the default social circles may initially be empty of contacts, and the user populates each of the default social circles as discussed in further detail herein.

As discussed herein, digital content can be distributed to contacts within the social networking service including one or more social circles, such that they are exclusively viewable by the indicated contacts and/or contacts within one or more indicated social circles. For example, a user of the social networking service can generate a post and indicate one or more social circles for distribution of the post. In some implementations, an auto-complete component enables the user to type in part of the name of a social circle and/or individual contact to specify which social circles and/or individual contacts require delivery of the post content. During a post write-time, a post data set is transmitted from the user's client computing device (e.g., client device 102 of FIG. 1) to a distribution hub, which can be provided at a server (e.g., server system 112 of FIG. 1). The post data set includes a plurality of data. In some implementations, the post data set includes post content data (e.g., text, uniform resource indicator (URI)), timestamp data (e.g., a timestamp indicating the time that the post was generated), distribution data (e.g., contacts and/or one or more social circles), and identification (ID) data (e.g., an ID assigned to the post data set upon generation of the post).

In some implementations, other data can be appended to post data sets. Example other data can be spam indication data and scoring data. In some examples, spam indication data can be appended to a post data set to indicate that the post data set is considered to be spam. In some examples, scoring data can include a social affinity score among other possible scoring data.

In some implementations, the scoring data can be recipient specific. In some examples, the scoring data can include social affinity data that is provided based on respective social affinity scores between an author of the post and each recipient of the post. For example, a first user can author a post and define a distribution of the post, creating an underlying post data set. The distribution can include a second user and a third user. A first social affinity score associated with a social relationship between the first user and the second user can be provided, and a second social affinity score associated with a social relationship between the first user and the third user can be provided. The first social affinity score can be different from the second social affinity score, reflecting different social relationships between the first user and the second user and the first user and the third use. The first social affinity score and the second social affinity score can be appended to the post data set and/or stored in another location while maintaining an association with the post data set.

In some implementations, the distribution data is processed to provide an access control list (ACL) that specifies which contacts within the social networking system are granted access to the post content. In some implementations, social affinity scores can also be processed to provide the ACL. For example, the distribution data can indicate that the post content is to be accessible by and/or distributed to a particular user. A social affinity score can be determined for the post and can be specific to a relationship between the post recipient and the author of the post. In some examples, if the social affinity score is below a threshold score, it is determined that the post content will not be accessible by and/or distributed to the particular user. Consequently, although the particular user had been explicitly targeted for distribution of the post by the author, the particular user is not provided in the ACL for the post. In some examples, if the social affinity score is at or above the threshold score, it is determined that the post content will be accessible by and/or distributed to the particular user. Consequently, the particular user had been explicitly targeted for distribution of the post by the author and the particular user is provided in the ACL for the post.

Generally, the distribution hub determines end points the post data set is to be distributed to, based on the ACL. More specifically, the set of contacts that may care about the post and/or that are allowed access to the post is determined based on the ACL, and the ID of the post is written to a per user/view index at the distribution hub. When fetching posts to distribute to a user, the user/view index is accessed and the IDs of the various posts that the user is allowed to view are determined. The post data sets are retrieved from a data store (e.g., data store 118 of FIG. 1) and are transmitted to a client device associated with the requesting user. In some implementations, the ACL can be provided based on the overall score, the quality score and/or the social affinity score.

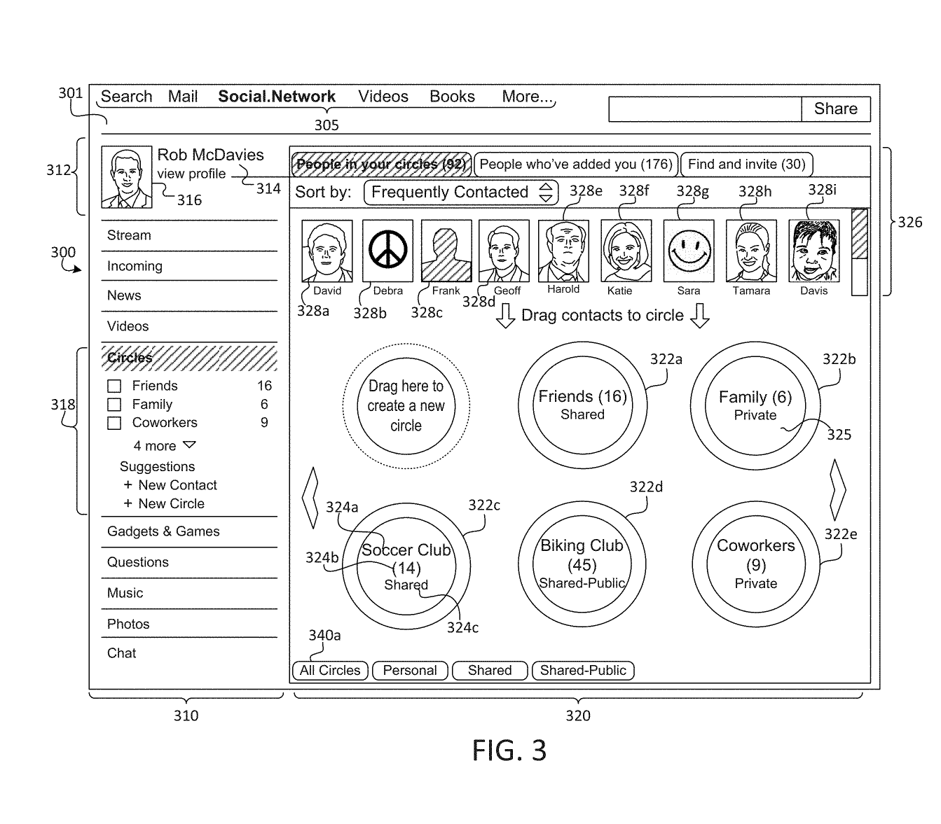

FIG. 3 depicts a screen-shot 300 of an example graphical user interface for creating and maintaining social circles. In the screen-shot 300, a social graph editor user interface (UI) 301 is shown. In some implementations, the UI 301 can be the interface presented by a social networking application, while in some implementations the UI 301 can be one or more Web pages of a social networking Web site displayed in a general purpose Web browser.

In the example of FIG. 3, the UI 301 includes a number of choices presented in a menu bar 305. In the present example, the “Social Network” choice has been selected by a user. This selection causes a Web-based social networking application to be executed and a social network menu 310 to be displayed. The social network menu 310 includes a profile indicator 312 in which information, e.g., a user name 314 and a user image 316 associated with the currently logged in user are displayed.

The social network menu 310 also displays, among other items, a social circles sub-menu 318. The social circles sub-menu 318, when selected (e.g., as represented by the highlighting of the submenu's title), causes a social circle display 320 to be presented. The social circle display 320 includes a number of circles 322a-322e that are visual representations of various social circles that the user has created or has permission to edit. Each of the circles 322a-322e displays information about the social circle it represents. For example, the circle 322c displays a name 324a, a count 324b of the number of contacts associated with the social circle, and an indication 324c of what kind of circle (e.g., personal, private shared, public shared) that the circle 322c is.

The social circle display 320 also includes a contact display 326. The contact display 326 provides a graphical interface for viewing, selecting, and organizing items in the user's contact lists. A collection of contact icons 328a-328i represents the contacts or other entities (e.g., organizations, places, or other items) socially networked with the particular user. In some implementations, the icons can be digital photos of the contacts they represent (e.g., the icons 328a, 328d), arbitrary images (e.g., the icons 328b, 328g), or placeholders (e.g., when the contact has no image associated with their account, e.g., the icon 328c). In some implementations, the icons can include additional information, e.g., the names of each contact. A scroll bar may be provided for the user to view additional contact icons that may not fit into the initial view.

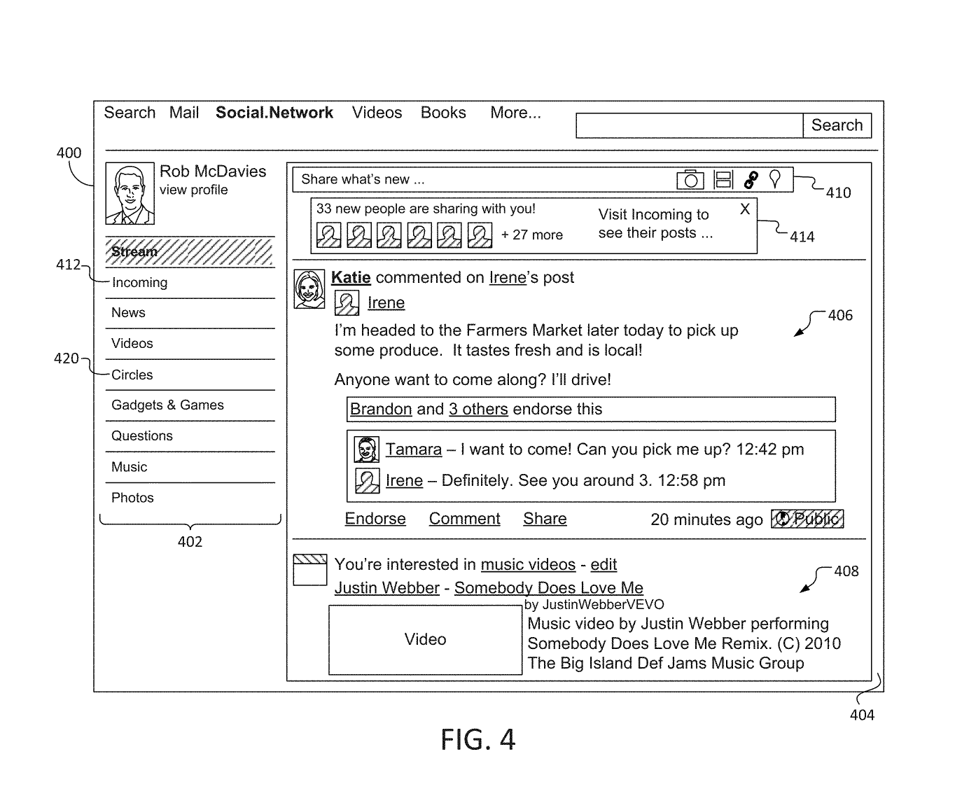

FIG. 4 depicts a screen-shot of an example main stream page 400 for a user of a social networking service. For example, the page 400 can be provided as a Web page within a Web site of a social networking service, and can display digital content that has been shared with a user associated with the page 400. In the illustrated example, the example user includes “Rob McDavies” and the stream page 400 displays, in a main content stream, items (i.e., digital content) that other users have shared with the user and/or items that the user has shared with other users. The stream page 400 includes a social network menu 402 and an item region 404. Example items 406, 408 that have been distributed to the user are displayed in the item region 404. Generally, the items 406, 408 displayed in the item region 404 include digital content that is distributed to the user from contacts established within the social networking service. A content sharing interface 410 can also be provided in the item region 404. The user can activate (e.g., click on) the content sharing interface 410 to share digital content. Although two items 406, 408 are depicted in FIG. 4, it is appreciated that the stream page 400 can display a number of items to the user.

The processes described herein may be used to determine which content items to display to the user in the user's main stream. For example, control mechanisms may be provided to specify the amount of content to include in a user's main stream from one or more content sets. These content sets may include, e.g., content streams associated with the user's social circles or, as described below, other content that need not be from, or associated with, the user's social circles.

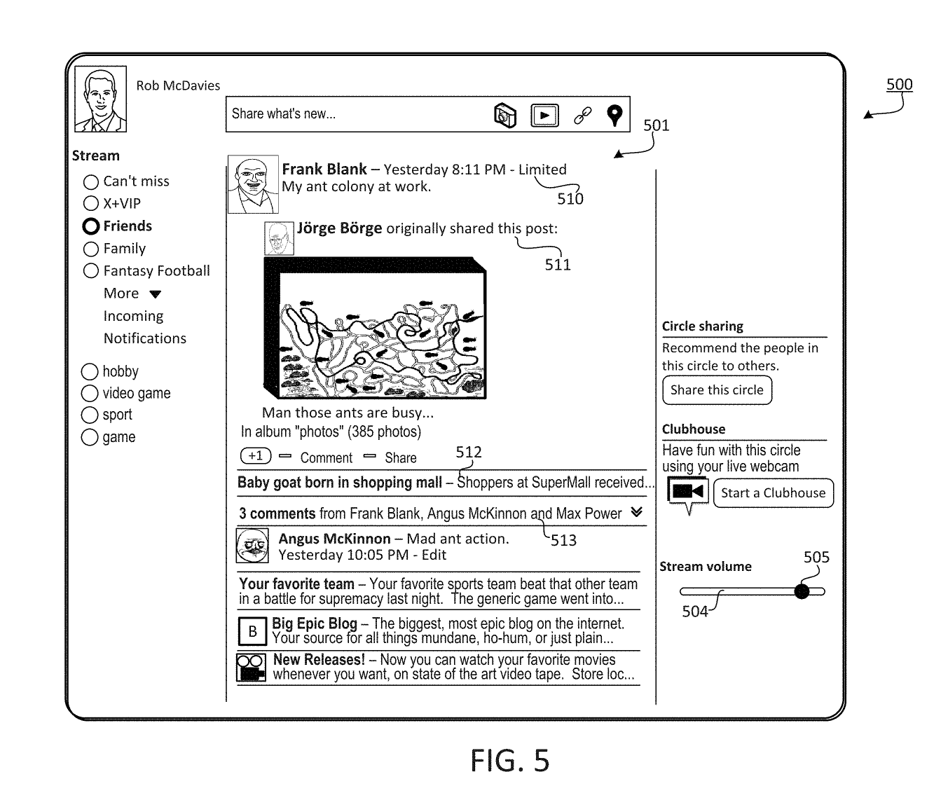

In this regard, FIG. 5 is an example Web page 500 showing a content stream 501 for a group. In this example, the group is a social circle entitled “Friends”. The social circle may be reached, e.g., by selecting item 420 of FIG. 4. Content stream 501 includes content from social contacts of the user (in this example, Rob McDavies), who the user has designated as a friend (versus, e.g., family, work colleagues, and so forth).

Web page 500 also includes control mechanism 504. Control mechanism 504 is a slider in this example implementation, however, other appropriate control mechanisms may be used instead of, or in addition to, the slider that is shown. Control mechanism 504 allows the user to control, through left or right movement of control 505, the amount of content from the social circle “Friends” to include in the user's main content stream. The amount of content to be included may be one of plural discrete amounts that correspond to the location of control 505 along the slider. For example, the amount may correspond to “nothing”, in which case no content from social circle “Friends” is included in the user's main content stream. This setting may correspond, e.g., to the far left of the slider. The amount may correspond to “some content”, in which case a first amount content from social circle “Friends” is included in the user's main content stream. This setting may correspond, e.g., to the slight left-of-center on the slider. The amount may correspond to “most content”, in which case a second amount of content from social circle “Friends” is included in the user's main content stream. This second amount of content may be more than the first amount of content noted above. This amount may be set, e.g., by process 1700, which is described in more detail below. This setting may correspond, e.g., to the slight right-of-center on the slider. The amount may correspond to “everything”, in which case the content from the social circle “Friends” is included in the user's main content stream. This setting may correspond, e.g., to the far right of the slider. In other examples, the amount of content is not limited to four discrete settings.

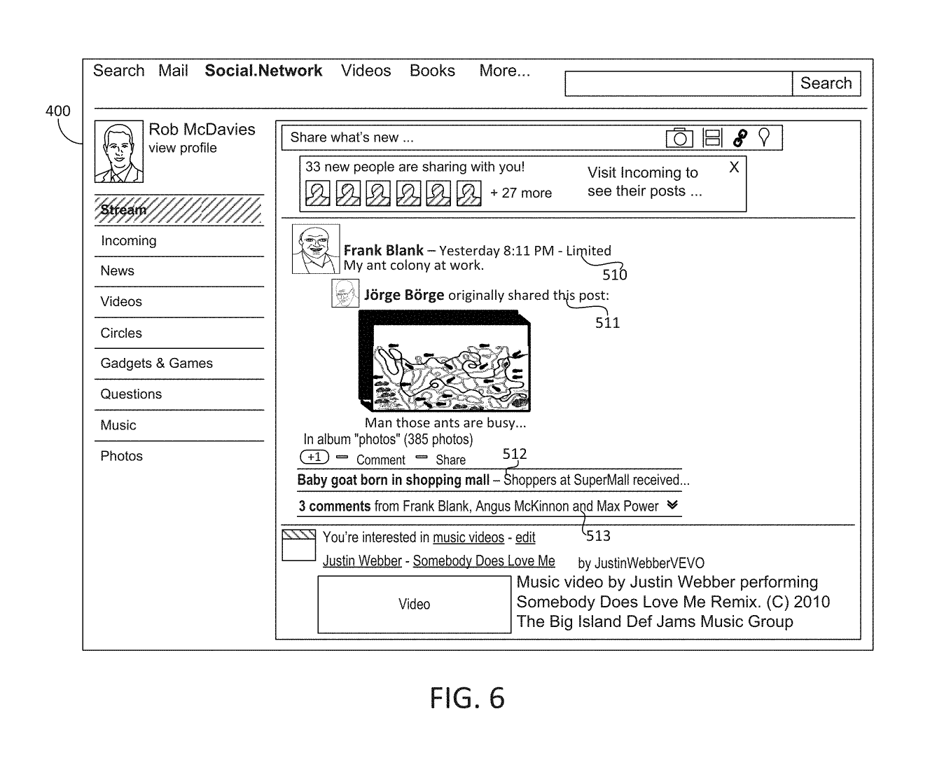

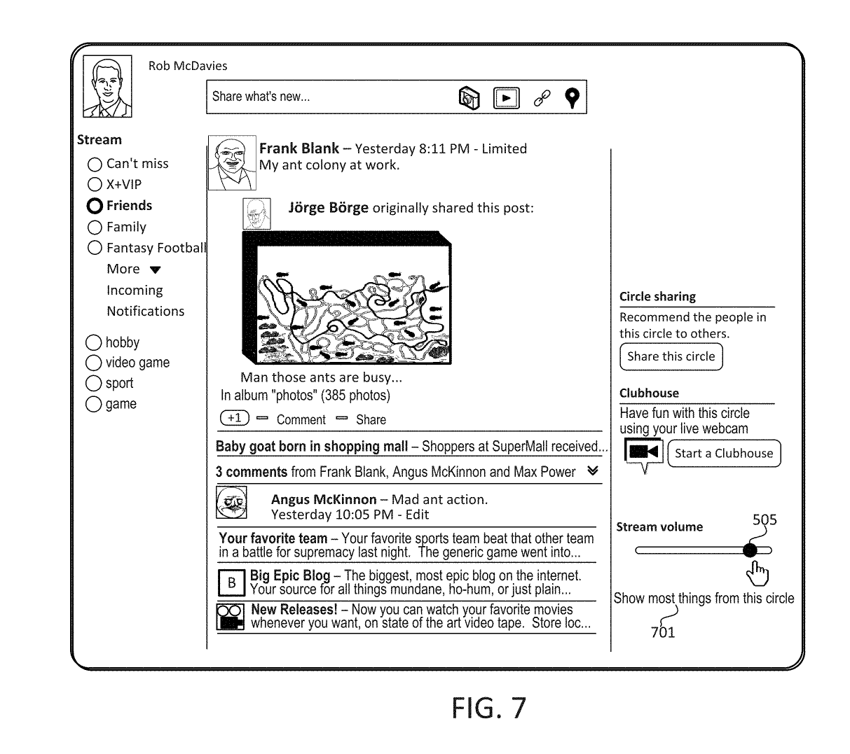

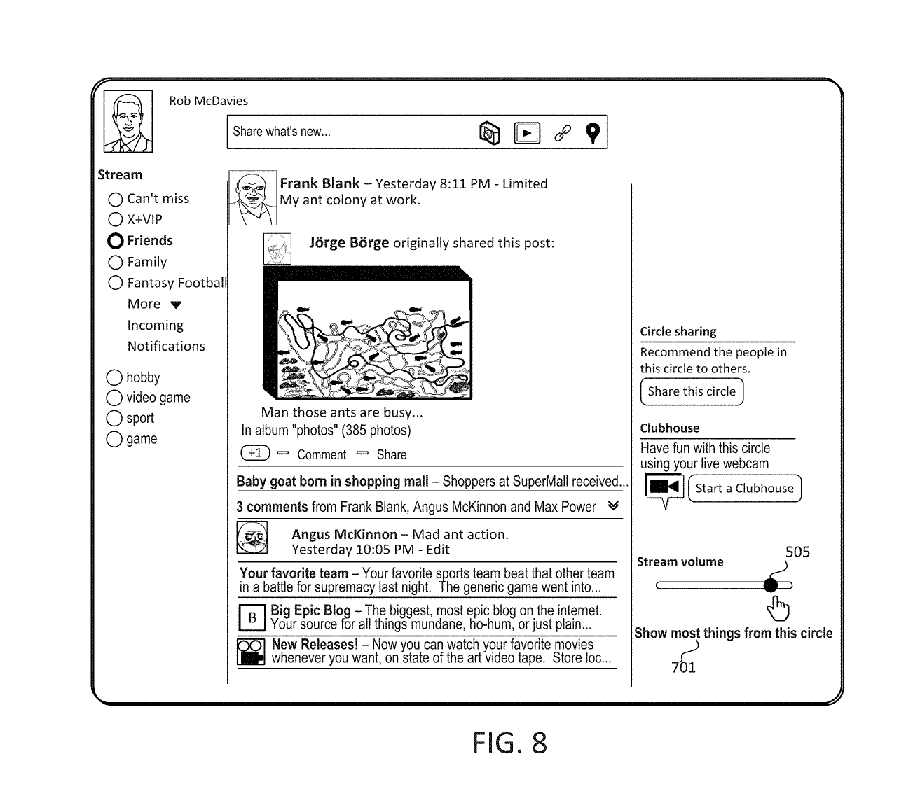

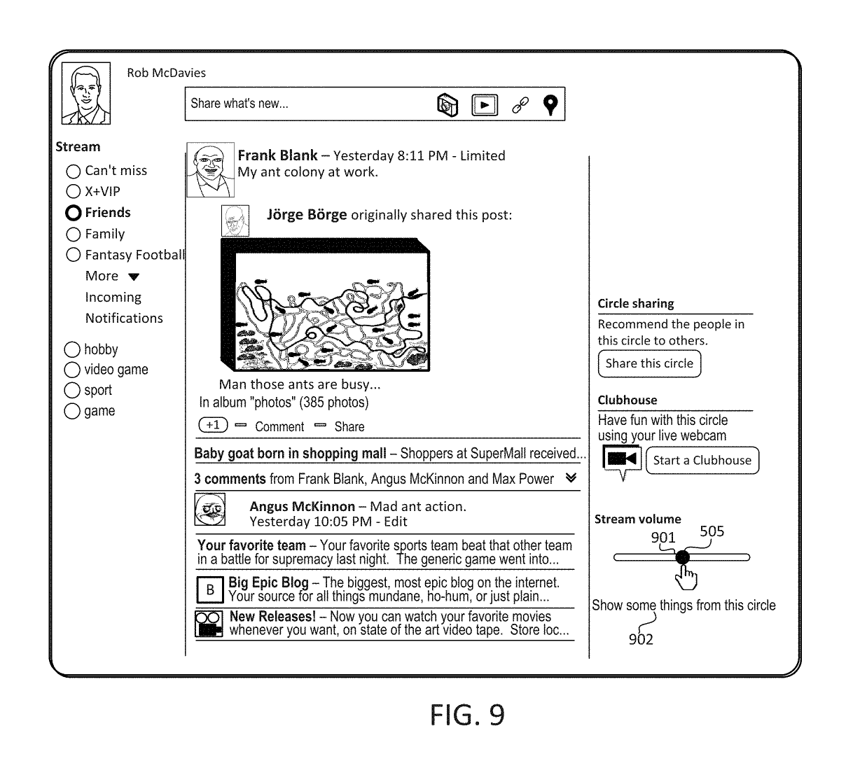

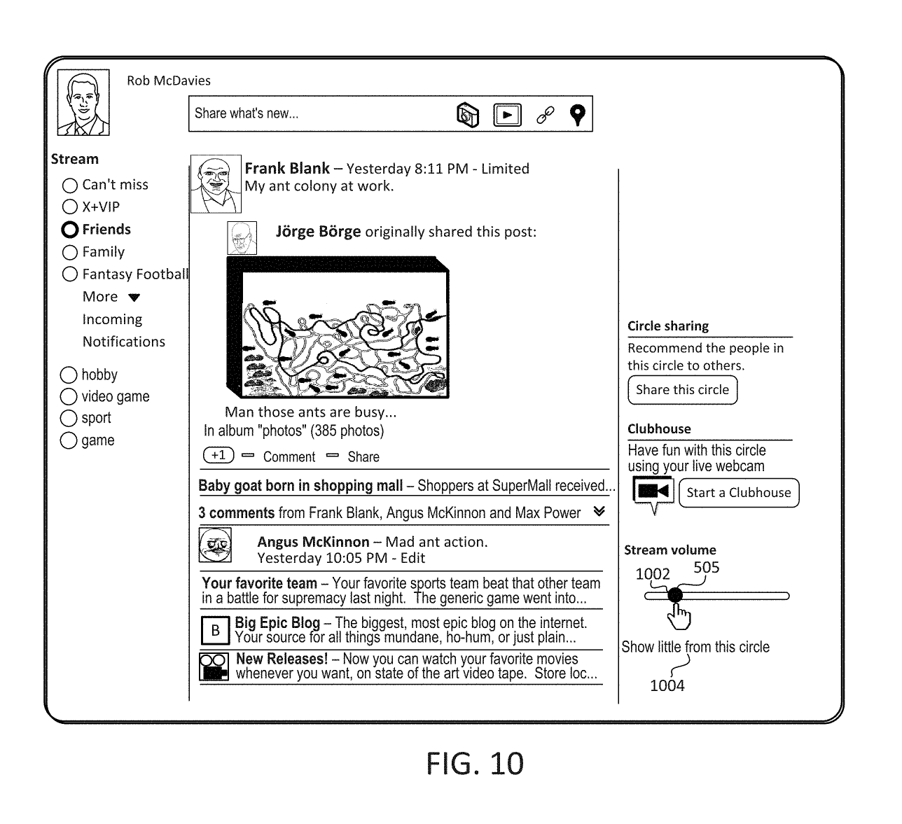

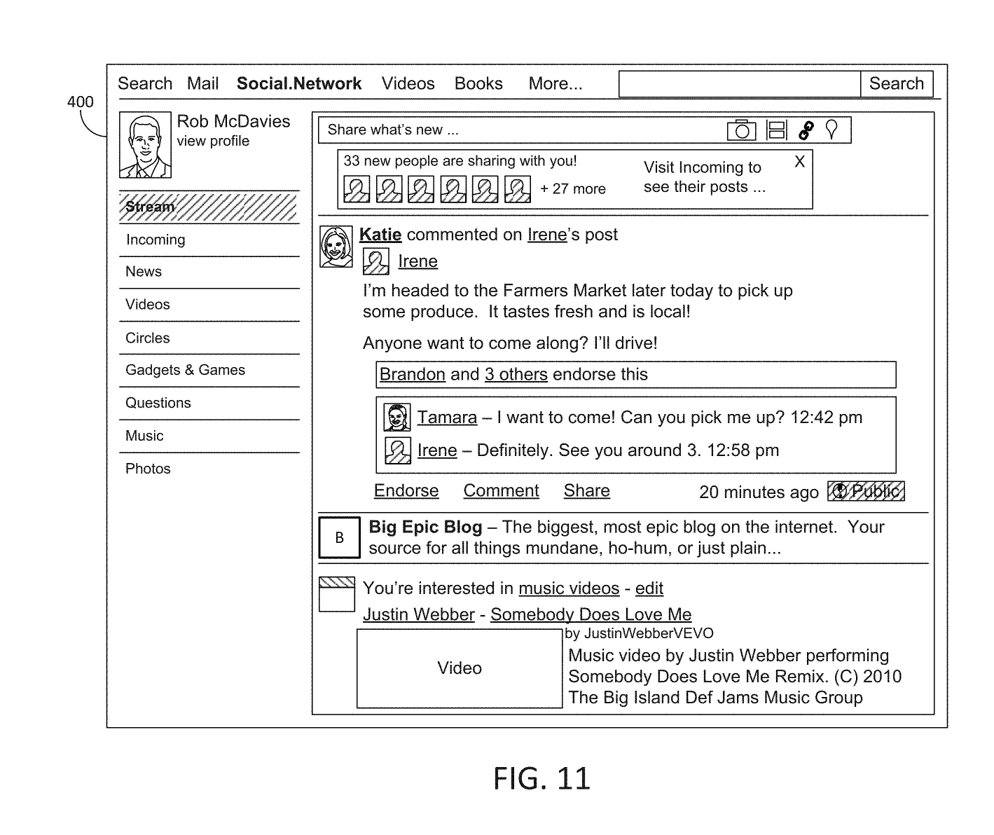

In the example of FIG. 5, control 505 is right-of-center in the slider, indicating that most content from content stream 501 is to be incorporated into the user's main stream. An example in which most content is included in the user's main stream is shown in FIG. 6. There, content items 510 to 513 are incorporated from content stream 501 (FIG. 5) into the user's main stream (FIG. 6). Referring to FIG. 7, when a user mouses-over control 505 of the slider, a message 701 indicating the amount of content displayed when control 505 is at the depicted location is presented, e.g., “Show most things from this circle”. Referring to FIG. 8, when the user selects (e.g., clicks-on) control 505, message 701 becomes darker. Referring to FIG. 9, when the user moves control 505 of the slider towards the left, to position 901, message 902 is presented. In this example, message 902 is “Show some things from this circle”. Referring to FIG. 10, when the user moves control 505 of the slider further left, to position 1002, message 1004 is presented. In this example, message 1004 is “Show little from this circle”. When the user releases control 505, message 1004 becomes lighter, whereafter message 1004 disappears (not shown). Referring to FIG. 11, the user's main stream is shown when control 505 is at position 1002 (FIG. 10). Contrasting the user's main stream in FIG. 11 to the user's main stream in FIG. 6, less content from content stream 501 is presented in the user's main stream in FIG. 11 than in the user's main stream in FIG. 6. In this example, this difference is due to the setting of control 505 on the slider.

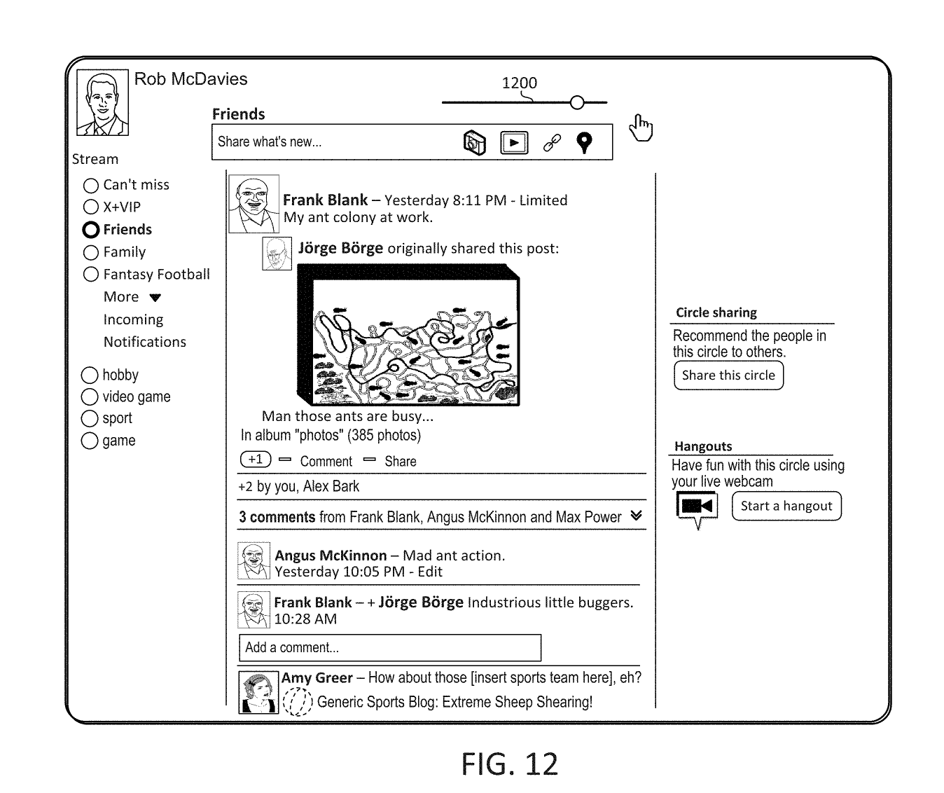

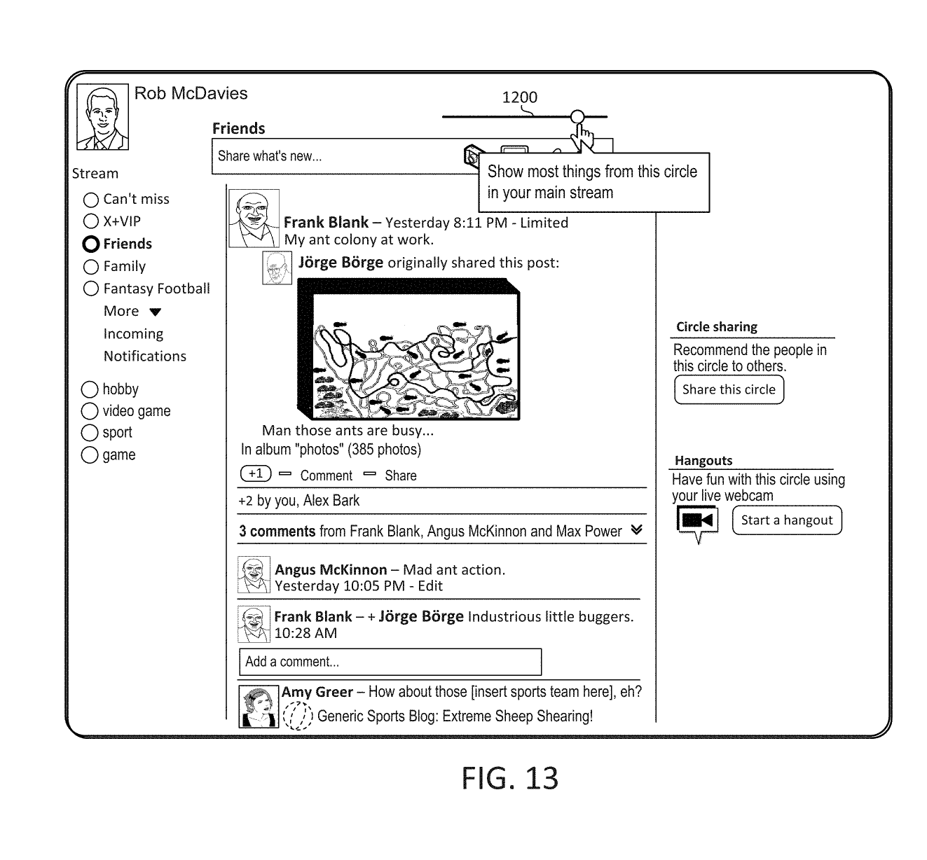

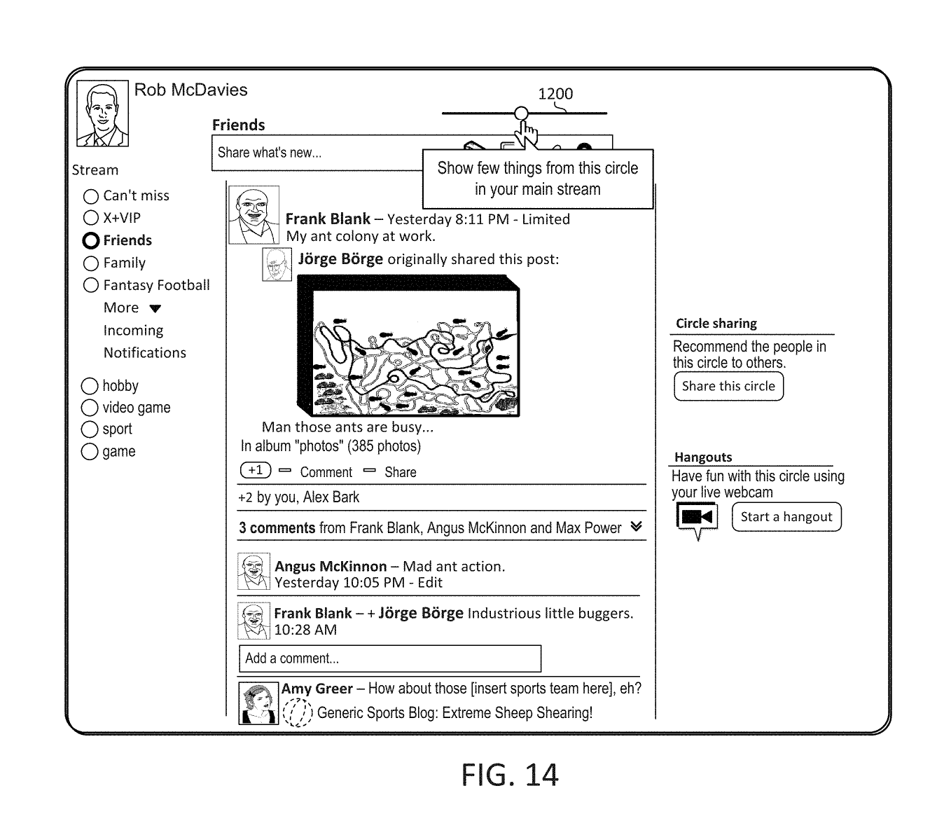

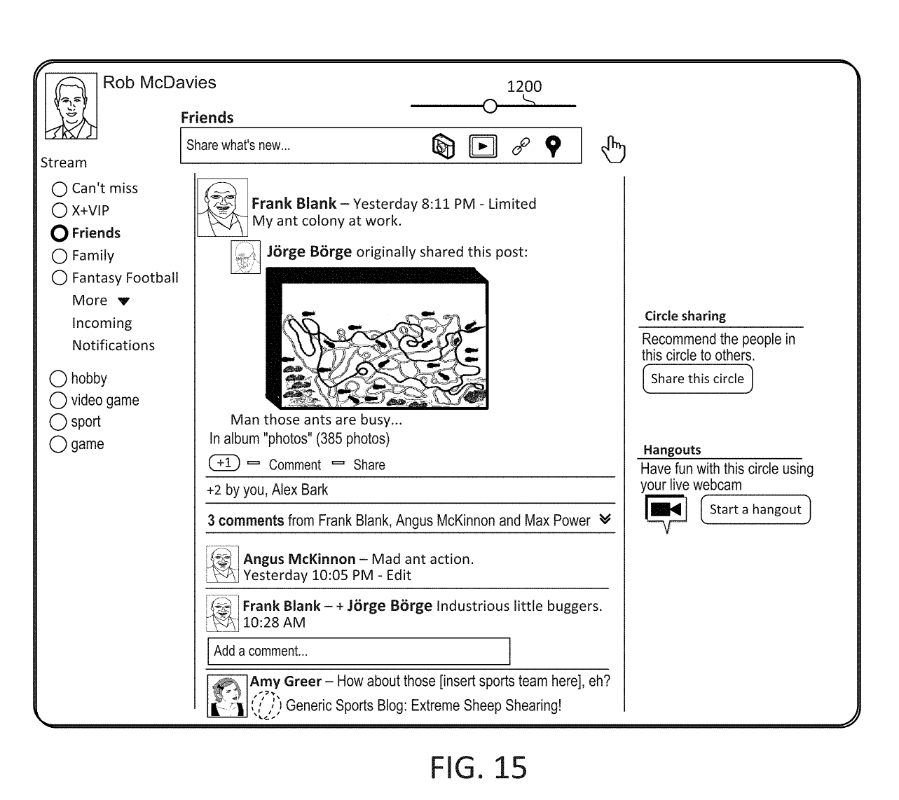

FIGS. 12 to 15 show control mechanism 1200 at a different location than in in the foregoing figures. Operation of control mechanism 1200 is substantially the same the operation of control mechanism 504. However, in FIGS. 12 to 15, the messages have a different display format and may display slightly different content. The effect on the user's main stream, however, is substantially the same for control mechanism 1200 as for control mechanism 504.

In operation, the social networking service outputs, to a client device, data for a first graphical user interface that includes the control mechanism described above for specifying an amount of content from, e.g., a social circle, to include in a main stream. The client device renders an appropriate display, including the control mechanism, using that data. Through that control mechanism, the user specifies how much content to include in their main page from the social circle. The social networking service receives, through the control mechanism, information indicating the amount of content to be included in the user's main stream, and information indicating from where that content is to be included (e.g., the social circle). The social networking service identifies content according to the process described below based, e.g., on a score that is adjusted in accordance with the received information, and outputs data for a second graphical user interface that includes the identified content. The client device renders an appropriate user interface to display the main stream augmented with the identified content.

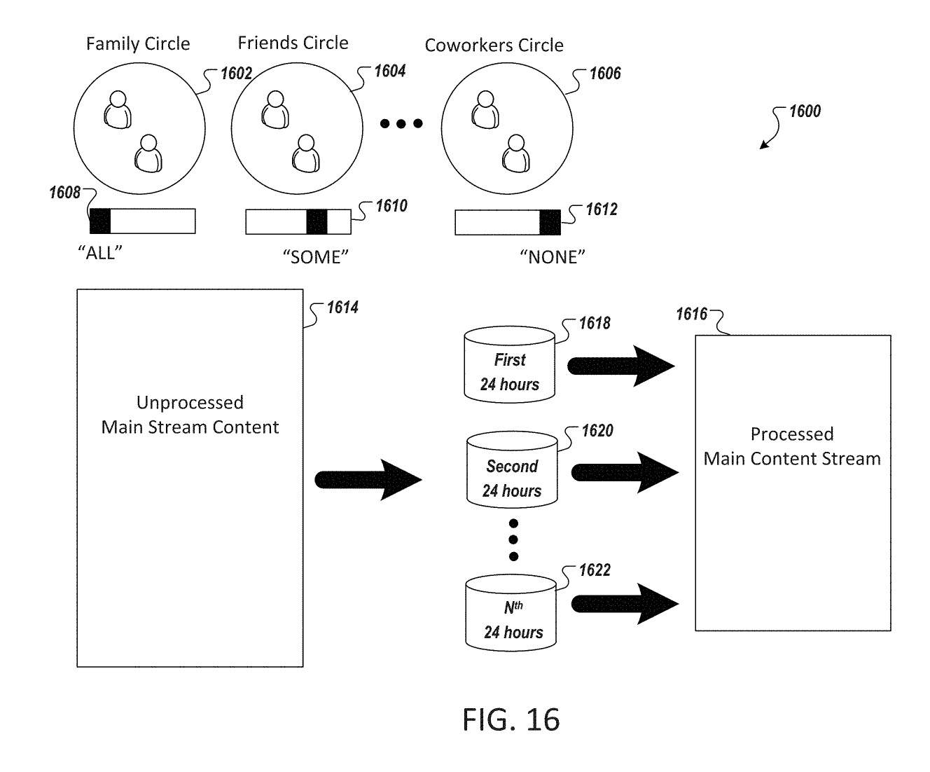

FIG. 16 is a graphical representation of a process 1600, which is described below, that illustrates an example of a method for determining which content is to include in the user's main content stream in response to settings of the social circle control mechanisms. In general, to reduce the amount of content included in the user's main content stream, content is selectively removed from the stream based upon the settings of control mechanisms, which indicate a desirable amount of content from the respective members of each social circle. In this example, three of many social circles are graphically represented. In particular, a “Family” social circle 1602, a “Friends” social circle 1604 and a “Coworkers” circle 1606 are presented. Each of the social circles 1602, 1604, 1606 has a corresponding control mechanism (e.g., sliders 1608, 1610, 1612) that allows a user to select a desirable amount of content to be included in the user's main content stream, thereby providing the user with a control mechanism to dynamically reduce or increase the amount of content presented (based upon which social circle the author of the content is a member).

A variety of control setting may be defined for controlling the amount of content that is presented from the social circles. For example, four settings (e.g., identified as “NONE”, “SOME”, “NORMAL”, and “ALL”) may be defined for controlling the content for presentation. In the illustrated example, the slider 1608 has been positioned to the “ALL” setting to indicate that all content from members of the “Family” social circle 1602 is to be presented in the user's main content stream. The slider 1610 has been positioned to the “SOME” setting to indicate that less than all of the content from members of the “Friends” social circle 1604 is to be presented. Contrary to the “ALL” setting, the slider 1612 has been placed in the “NONE” setting to indicate that content from the membership of the “Coworkers” social circle 1606 should not be presented in the main content stream. While not illustrated in the figure, one or more of the sliders could also be placed into the “NORMAL” setting which would dictate an amount of content provided from the membership of the corresponding social circle. One or more definitions may be implemented to define the “NORMAL” setting, for example, the setting may indicate that all of the content from the social circle should be presented in the main content stream (e.g., similar to the “ALL” setting). In some arrangements, the “NORMAL” setting may indicate that a relatively large percentage of the content from the social circle is to be presented in the main content stream. While four distinct settings are described for this example (although the “NORMAL” setting is not illustrated as being used), more or less settings may be implemented to define a continuum of settings to control the amount of content presented in the user's main content stream.

To illustrate the process 1600 controlling (e.g., reducing) the amount of stream content presented based upon social circle membership of the author of the content, unprocessed main stream content 1614 is graphically illustrated. Based upon the settings of the social circle control mechanisms (as described above), the amount of content included in the unprocessed content 1614 is reducing to produce a processed main content stream 1616, which is graphically illustrated as having a smaller size compared to the size of the unprocessed main stream content 1614. For social circle control mechanisms set to “ALL”, content authored by members of this social circle is typically included in the processed main content stream 1616 and for social circle control mechanisms set to “NONE”, content is not included in the processed main content stream 1616. In some scenarios, a content author may be identified in two or more social circles that may have conflicting control mechanism settings (e.g., one control is set to “ALL” and another control is set to “NONE”). One more techniques may be used to address potentially conflicting settings, for example, one or more predefined rules may be used to determine the appropriate amount of content from the author for inclusion in the processed content stream 1616. For example, settings indicative of including the content in the stream may trump settings indicative of excluding the content (e.g., an “ALL” setting overrides a “NONE” or “SOME” setting).

Along with identifying content to be included based upon an “ALL” setting, one or more techniques may be implemented to determine the appropriate amount of content associated with a “SOME” control setting for being included in the processed main content stream 1616. In one technique, for a family circle (or family circles) with a “SOME” setting, the content is grouped based upon it's receive time and then scored and ranked to identify the appropriate content for the processed main content stream 1616. As illustrated in the figure, a series of content “buckets” are used to group the received content based upon the individual receive time. For example, each content bucket may represent a predefined time period (e.g., a twenty-four hour period) from the last time that the user viewed the main content stream. As illustrated in the figure, a content bucket 1618 includes the content received (within twenty-four hours of the user's last visit) from social circles with “SOME” control mechanism settings. Content bucket 1620 includes the content received during the next time period (e.g., the next twenty-four hour period) and the progression continues to a content bucket 1622 (e.g., for the n^{th} twenty-four hour period). While a twenty-four hour time period is used in this example, longer or shorter time periods may also be implemented. Further, besides receive time, one or more other criteria, individually or in combination with receive time, may be used for grouping content. The frequency that a user visits his or her main content stream may also be used to determine the amount of content to be presented in the stream. For example, for a more frequent user (e.g., visits their main content stream every four hours rather than once a day) more content (e.g., from the content buckets) may be inserted into the stream (e.g., forty items per day are inserted into the stream rather than twenty-five items being inserted per day).

Grouped into the content buckets 1618,1620, . . . , 1622, one or more techniques may be used for selecting content from the buckets for being included in the processed main content stream 1616. For example, the content in each bucket may be scored and ranked for identifying the content for presenting on the main content stream. One or more scoring techniques may be implemented, for example, content may be scored reflective of the author of the content. For example, content authors may receive larger value scores based upon their relationship with the user (e.g., long standing and recent relationships) compared to authors and users without previous interactions. Communications between the author and the user may be measured (e.g., metrics calculated) from information provided from one or more social graphs (e.g., previous postings, electronic messages exchanged between the individuals, relationships through social circles, etc.). Scoring may also reflect global factors that can be considered independent of author/user relationships (e.g., the number of comments posted by an author, comments read, comments replied to, etc.). Once the content is scored, one or more ranking technique may be used to rank the content in the content buckets. Typically, an equivalent ranking technique is used for each of the content buckets, however, in some arrangements different ranking techniques may be used for two or more different content buckets. Once ranked, content is selected from one or more of the content buckets 1618,1620, . . . , 1622 for inclusion in the processed main content stream 1616. One or more selection techniques may be used, for example, a predefined number of content entries in each content bucket may be selected (e.g., the top five content entries for each bucket are selected). An equivalent number of content entries from each content bucket 1618,1620, . . . , 1622 may be selected, or in some arrangements, different amounts of content may be selected from two or more of the content buckets for presentation in the processed main content stream 1616. A total number of entries to be presented in the stream may also be used to dictate the amount of content selected from each content bucket. For example, the processed main content stream 1616 may be constrained to twenty-five of less content entries from authors that are members of social circles with a “SOME” setting on the corresponding control mechanism.

In some arrangements, after content has been selected (e.g., based upon the best scores) and provided to the processed main content stream 1616 for presentation, content remaining in the content buckets may be further processed (e.g., for future selections, for picking the best selections in a repetitive manner). One or more processing techniques may be used for processing the remaining content, for example, the content in one or more of the content buckets may be re-scored and re-ranked to identify the next set of content for inserting into the main content stream. To increase the diversity of the content provided from the content buckets to the processed main content stream, additional information may be used for re-scoring the remaining content to improve the ranking of other content authors, social circle members, groups, etc. For example, a penalty score may be applied to content still residing in the content buckets that was produced by an author whose content has previously been selected for presenting on the processed main content stream 1616. After the one or more penalty scores are applied, the related author may be ranked lower, thereby allowing one or more other content authors (e.g., a non-penalized content author) to be selected for content presentation on the processed main content stream 1616. Other bases may be used for applying penalty scores, for example, penalties may be applied to content from the same group (to which a member author's content has been presented), thereby improving the diversity of content being presented among different groups (e.g., social circles, individuals discussing particular topics, etc.). Control mechanism settings may also factor in defining and applying penalties, for example, different penalty values may be applied to content scores based upon the setting selected for the social circle to which the content author is a member. Larger penalty values may be used for social circles that have settings selected to reduce the amount of their content being presented. Correspondingly, relatively smaller penalty values (or no penalty value) may be used for social circles that have settings selected to allow a reasonable amount of their content to be presented in a content stream.

The processed main content stream 1616 typically presents a predefined amount of content from authors of social circles with control mechanisms set to “SOME”. For example, presentation may be limited to twenty-five content entries, thereby reducing the amount of information presented to the user. Along with the predefined number of content entries, additional content may be included (e.g., appended) in the processed main content stream 1616. For example, content from social circles associated with an “ALL” control setting are typically inserted into the processed main content stream 1616. Content entries that have been previously read by the user (e.g., previously presented and read from the user's main stream) may also be inserted into the content stream to provide continuity to the user when viewing content. One or more rules may also be applied prior to presenting selected content, for example, each content author may be limited to a predefined amount of presented content. If determined that the author has exceeded the limit, selected content from that author may be removed prior to being presented. In some arrangements, prior to inserting the content from the various sources (e.g., the content buckets, content from social circles with an “ALL” control setting, etc.) additional processing operations may be executed. For example, the content for presentation may be sorted (e.g., chronologically ordered) prior to being inserted into the processed main content stream. Along with presenting, the content may be used in the execution of other operations. For example, the content to be presented on the processed main content stream 1616 may be stored (e.g., to create a record of presented content) for later access and retrieval.

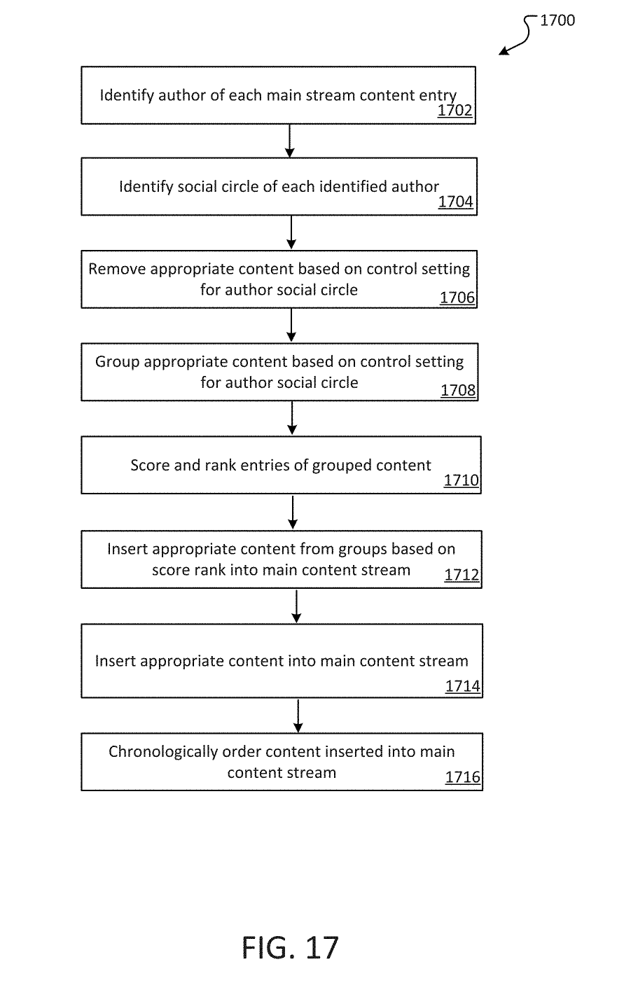

FIG. 17 is a flowchart 1700 of operations for a method for determining which content to include in a user's main content stream in response to setting social circle control mechanisms. The operations may be executed by one or more computing devices that may be positioned at a single location or distributed across two or more locations and capable of using one or more communication techniques (e.g., connected to one or more networks). In general, the operations allow an adjusted (e.g., reduced) amount of content to be selected for presentation in the user's main content stream based upon control mechanism settings of the social circles. Operations include identifying 1702 the author of each content entry of the unprocessed main stream content (e.g., illustrated in FIG. 16 as unprocessed stream content 1614). The author of a content entry could be the individual that created the content, provided the content for presentation in the main content stream, etc. Operations may also include identifying 1704 the social circle to which the identified author is a member. In some situations an author may be a member of multiple social circles and one or more predefined rules may be used to determine which control mechanism setting (e.g., “NONE”, “SOME”, “NORMAL”, “ALL”, etc.) is used to classify the author. For example, based upon the settings of the author's membership social circles, the setting most associated with presenting content (e.g., “ALL” overrides “SOME”, “SOME” overrides “NONE”, etc.) may be assigned to the author. Operations may include removing 1706 appropriate posts from the main stream content of the user based upon the setting of the author's social circle. For example, membership in a social circle that has a control setting of “NONE” would typically cause the author's content to be removed from presentation. Operations may also include grouping 1708 appropriate content based upon the control setting of the author's social circle. For example, a social circle setting of “SOME” would typically cause the author's content to be grouped with other content based on one or more criteria (e.g., time content is received, etc.). Once grouped, the entries of each group of content (e.g., illustrated in FIG. 16 with content buckets 1618, 1620, . . . , 1622) may be scored and ranked 1710. For example, scoring may account for factors that represent the relationship of the user and the author (e.g., quantify the affinity of the user for the author, etc.) and factors that can be considered global (e.g., amount of content from the author that has been read, etc.). Once scored and ranked, operations may include inserting 1712 content into the main content stream of the user (e.g., illustrated in FIG. 16 as the processed main content stream 1616) from the content groups. For example, a predefined number of entries from each content group may be inserted for presentation (e.g., insert the top “n” content entries from each content group). Operations may also include inserting 1714 other content into the main content stream. For example, author content from one or more social circles that have a control mechanism setting of “ALL” may be inserted (e.g., appended) into the main content stream of the user. Other operations may also be executed prior to presenting the selected content, for example, the content may be chronologically ordered 1716 in the main content stream, thereby providing the user a listing of the content entries as received. Other operations may include applying a penalty (e.g., a penalty score) to other grouped content of the author to reduce the probability that more content from the same other would be presented in the stream from subsequent content selections. By applying penalties, a more diverse set of content is presented to the user and presentations are not monopolized by one or a relatively small set of authors for the user's social circles.

Although the control mechanism of described above is a slider, other control mechanisms may be used. For example, radio buttons may specify amounts of content to be included in a main stream. In an example implementation, there may be a radio button for “no content”, a radio button for “some content”, a radio button for “more content”, and a radio button for “all content”. In another example implementation, a pull-down menu, e.g., on the user's main stream page or elsewhere, may be used to specify the amount of content to include in the user's main stream. Other appropriate individual control mechanisms may be used. Settings provided by the control mechanisms may be considered continuous settings (e.g., continuous values), discrete settings (e.g., discrete values), a combination of continuous and discrete settings (e.g., continuous values and discrete values), etc.

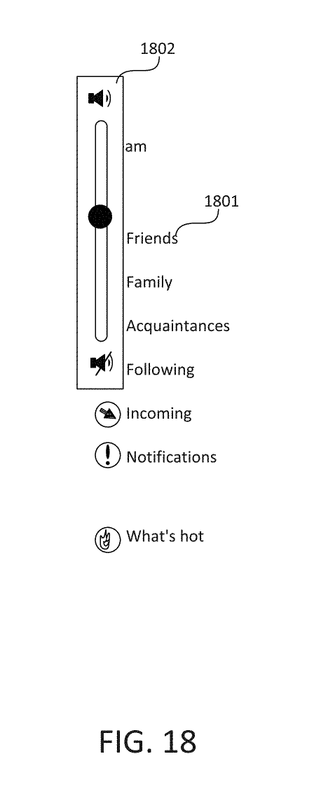

The control mechanisms need not be placed where shown in the above-described figures. In another example implementation, mousing over a group, e.g., a circle, may cause display of the control mechanism. For example, referring to FIG. 18, mousing over the “Friends” circle 1801 causes control mechanism 1802 to be displayed. In this example, the center of control mechanism 1802 is displayed at the location where “Friends” is displayed. Control mechanism 1802 operates in substantially the same way as the other control mechanisms described herein.

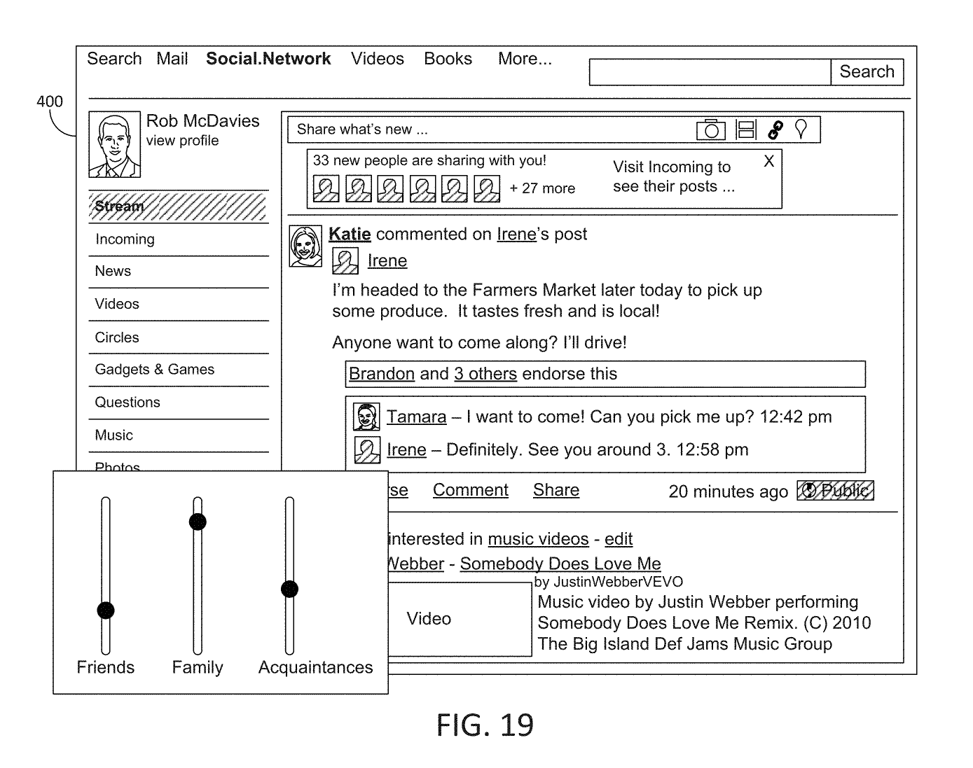

In other implementations, the control mechanism may be displayed, e.g., on a Web page containing the user's main stream. As shown in the example of FIG. 19, control mechanism 1901 may allow the user to control the amount of content included in the main stream from multiple content sets (e.g., from the “Friends”, “Family”, “Acquaintances”, and so forth circles or elsewhere). The individual elements of control mechanism 1901 may operate in a manner that is substantially similar to the operation of the other control mechanisms described herein.

The control mechanisms described above are configured to control the amount of content explicitly. However, in other implementations control over the amount of content included in the user's main page may be implicit. For example, a control mechanism (e.g., a slider) may be used to express a degree of affinity to, or interested in content from, a corresponding group (e.g., the “Friends” circle). The amount of affinity and/or interest reflected by movement of the slider may be translated, by process 1700, into an amount of content to incorporate from that group's content stream into the user's main stream.

The foregoing examples describe incorporating content from a group (e.g., a “Friends” circle) into the user's main stream. However, the control mechanisms and processes described herein may be used to control the amount of content from an individual that is to be included in the user's main stream. For example, a separate control mechanism may be associated with the user's individual social contacts (e.g., members of the user's social graph) who may be accessed through Web page 400. The user may mouse-over a contact to cause a control mechanism like that described herein to be displayed. By adjusting that control mechanism, the user may control the amount of content from that individual contact to be included in the user's main stream.

In some instances a user's main stream may not be fully populated and in the extreme, completely empty. For example, just starting to interact with a social networking service, a user may not have developed a collection of circles (e.g., including friends, co-workers, etc.). As the user may need time to develop social connections and relationships (e.g., build up circle memberships), the user's main stream may appear to be stagnate over this time period. Not being presented current and changing content (in a main stream), the user may become bored or frustrated and may reduce the frequency of viewing the main stream or perhaps even discontinue use of his or her main stream and the service entirely.

To retain the interest of users during slow or dormant periods of their mainstreams (e.g., as a user's circle membership is being developed), one or more techniques and methodologies may be implemented. For example, publicly available content may be inserted into a user's main stream to bolster interest and continue to keep the user engaged with the provided service. For one technique, publicly available content may be mixed in with main stream content from other sources (e.g., postings from circle members, etc.). Such publicly available content may be provided from various types of sources, for example, postings from individuals that have indicated (e.g., authorized) that their postings be publicly shared without restriction may be considered as publicly available. Businesses, associations, organizations, and other types of entities (e.g., groups) that publicly release information may also be collected and inserted into a user's main stream. In some arrangements, the public information may be filtered (e.g., subsets of information selected) based upon one or more criteria prior to being inserted into one or more user main streams. For example, based upon characteristics, interests, etc. of a user (e.g., as provided by a user profile), publicly available content may be identified and selected for inclusion in a main stream. Through such processing efforts, information may be provided that resonates with a user and potentially retain the user's interest (e.g., as circles are populated with members).

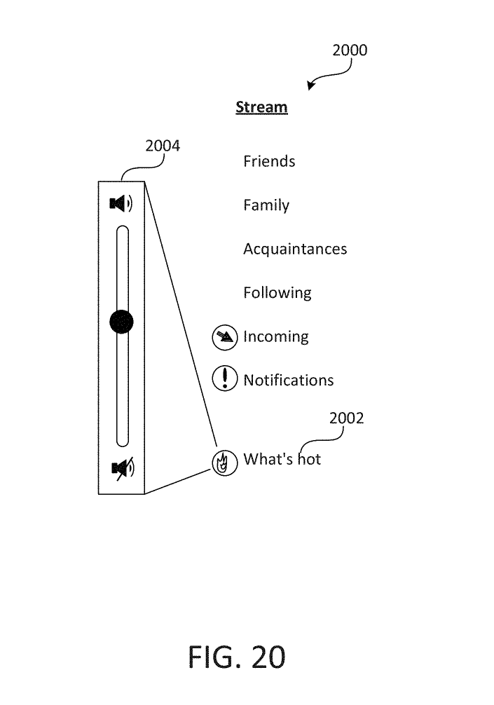

One or more techniques may be utilized for controlling the insertion of such publicly available content. For example, similar to other described arrangements one or more control mechanisms may be used to control the amount of publicly available content being mixed into a user's main stream. Referring to FIG. 20, listing of main stream sources 2000 is illustrated as including circles of a user (e.g., labeled “Friends”, “Family”, “Acquaintances”, etc.). Another source in the listing 2000, which is represented by an entry labeled “What's hot” 2002, may be selected by a user for having his or her main stream populated with publicly available content. Similar to the circles associated with a user, the amount of publicly available content inserted into a main stream may be controlled (e.g., by the user). For example, a control mechanism (e.g., graphically presented as a slider 2004) may be operated by a user to define the amount of content to be inserted into the user's main stream. In this example, a continuum of content to be inserted as provided by an upper limit of the slider 2004, which indicates that a significant amount of publicly available content should be inserted into the user's main stream, and by a lower limit that indicates that no publicly available content is to be inserted into the user's main stream. One or more implementations may be used for providing the control mechanism, for example, a dedicated control mechanism may be presented on an interface for controlling the amount of publicly available information to be inserted into a stream. In one arrangement, the appearance of the slide 2004 may be triggered by a graphical pointer (e.g., controlled by a mouse) hovering over a corresponding display location (e.g., the pointer is placed over the respective listing entry labeled “What's hot” 2002). A default setting may be used in some arrangements for controlling the amount of publicly available information to be inserted into a main stream. As such, the user is not required to select the amount of publicly available content to insert in some arrangements.

Once an amount has been selected (or a default setting applied) for inserting publicly available information (e.g., by adjusting the slider 2004), one or more techniques may be implemented for carrying out the insertion. For example, the information may be mixed with postings from other sources (e.g., circle members), e.g., to increase the population of user's stream. For one arrangement, a fixed number of publicly available postings may be inserted based upon the setting of the control mechanism (e.g., six posts are inserted each day for an upper limit setting, three posts are inserted each day for a mid-range setting, and zero insertions for setting the control mechanism to the lower limit setting of the slider scale). Similar to mixing in fixed quantities of public postings, other techniques may be implemented. For example, along with the setting of the control mechanism (e.g., slider 2004), other factors may be considered in determining the amount of public information to be inserted into a main stream. One factor may include main stream activity. For example based upon a predefined threshold, a stream may be identified as being less active and more public postings are used to populate the main stream compared to a stream identified as active or heavily active. Along with the activity of the user's main stream, the setting of a control mechanism is taken into account. For example, if a stream is identified as being less active and a corresponding control mechanism (e.g., the slider 2004) has been set for a relatively high level, a significant amount of public postings may be inserted in the main stream. Alternatively, for a heavily populated main stream (e.g., with posting from members of the user's circles), less public postings may be inserted.

In some arrangements the setting of a control mechanism is given preference over the amount of postings being provided to a main stream by circle members. For example, a main stream may be provided a considerable amount of posting from circle members while the control mechanism has been set to indicate a high value. With the control mechanism given preference in this situation, the main stream would be populated with posted from public sources even though the stream is well populated with postings from circle members. In effect, the setting of the control mechanism can be considered as overriding the amount of posts being provided from circle members. In another arrangement, preference may be given to the user's circle(s) membership(s). For such an arrangement, postings being provided from public sources may be reduced if a significant number of postings are being provided by circle membership. One or more techniques may be implemented to give preference to a user's circles. For example, if the posting provided from circle members reaches or exceeds a predefined threshold, amount of posting from public sources may be limited or halted. Along with using one or more thresholds, other techniques may be implemented for defining the amount postings to be presented from circle membership and publicly available sources.

Positioning of publicly available postings in the main stream may also depend upon the amount of postings from members of a user's circles. For example, postings originating from circle members may be considered as having a higher priority compared to publicly available postings. One or more techniques may be implemented for prioritizing postings, for example, a predefined number of circle-based postings may be identified for being positioned higher in a main stream than publicly available postings. In one arrangement, a fixed number (e.g., four, five, six, etc.) circle member postings, if present, are positioned in the user's main stream before any publicly available posts. By prioritizing circle member postings to be more predominate in a main stream than publicly available postings, a user's interest in the provided service may be improved by making circle member postings more noticeable.

Similar to adjusting the positioning of postings in a main stream to increase user interest, one or more techniques may be used to for mixing publicly available posts and member circle posts for presentation in a user's main stream. For example, mixing may be executed in a deterministic manner (e.g., interleaving a predefined number of publicly available posts and circle member posts, etc.), in a random manner, in a combination of deterministic and random manners, etc. Inserting postings into a main stream may also include a temporal aspect. For example, inserted postings may be retained for a predefined period of time. In one arrangement, publicly available postings may be inserted and retained in a main stream for at least two hours during the course of a day. However, to keep postings current, a publicly available posting may not be retained in a main stream beyond a predefined time period (e.g., twenty-four hours). By presenting new postings every day, a user may be more likely to not become bored with the content of a main stream and remained interested in the provided service.

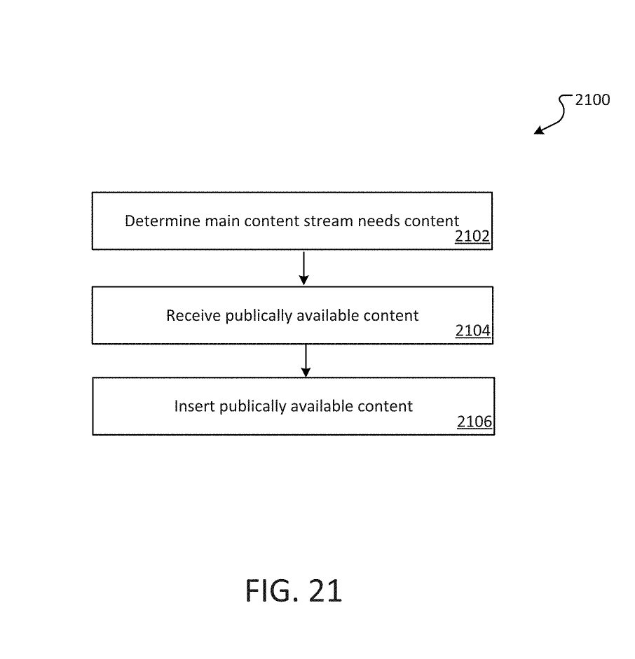

FIG. 21 is a flowchart 2100 of operations for a method for inserting publicly available content into a user's main content stream in response to a setting of a control mechanism. The operations may be executed by one or more computing devices that may be positioned at a single location or distributed across two or more locations and capable of using one or more communication techniques (e.g., connected to one or more networks). In general, the operations allow an amount of publicly available content to be presented in the user's main content stream, for example, to increase the population of the content stream for retaining the interest of the user. Operations include determining 2102 that the main content stream is in need of content. For example, such a condition may be indicated by a user's interaction with a control mechanism (e.g., dialing up a value represented by a slider). In another arrangement, one or more processes may be used to monitor the amount of content in a user's main stream and determine if content population should be increased for retaining user interest. Once determined, operations include receiving 2104 publicly available content, for example, for public sources, sources (e.g., individuals) that have indicated their content may be shared, etc. Operations also include inserting 2106 the publicly available content into the main content stream of the user to continue to draw the attention of the user and continue their interest in the social networking services being provided.

The processes described herein are described in the context of incorporating content from one content stream (e.g., the content stream for the user's “Friends” circle) into another content stream (e.g., the user's main content stream). However, the processes may be used to include content from an appropriate content set in another appropriate content set. For example, the processes (and control mechanism(s)) may be used to incorporate content from a saved search, or from entities associated with that search, into a user's main stream. For example, a user may save a search directed to the Boston Red Sox, resulting in a display of an icon through which the search content may be accessed. The search may contain posts by a known expert on the Red Sox. Through the processes described herein, the user may control the amount of content from that search, or from that particular expert, in the user's main stream. For example, the control mechanism may be associated with the icon to control the amount of content associated with the save search to include in the main stream. Likewise, the processes may be used to control how much content to include in the main stream that is associated with members of a user's social graph, e.g., popular posts on a social networking service, posts of friends, posts of friends of friends, posts of groups the user belongs to, and so forth. The processes may also be used to control the amount of content about particular subject matter, e.g., posts about games, posts about photographs, and so forth to include in the main stream.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

The processes described herein and variations thereof (referred to as “the processes”) may contain functionality to ensure that party privacy is protected. To this end, the processes may be programmed to confirm that a user's membership in a social networking account is publicly known before divulging, to another party, that the user is a member. Likewise, the processes may be programmed to confirm that information about a party is publicly known before divulging that information to another party, or even before incorporating that information into a social graph. In this regard, as noted elsewhere herein, privacy features provide a user with an enable/not enable option to allow or to prevent, respectively, their private or proprietary content from being included in the content streams described herein.

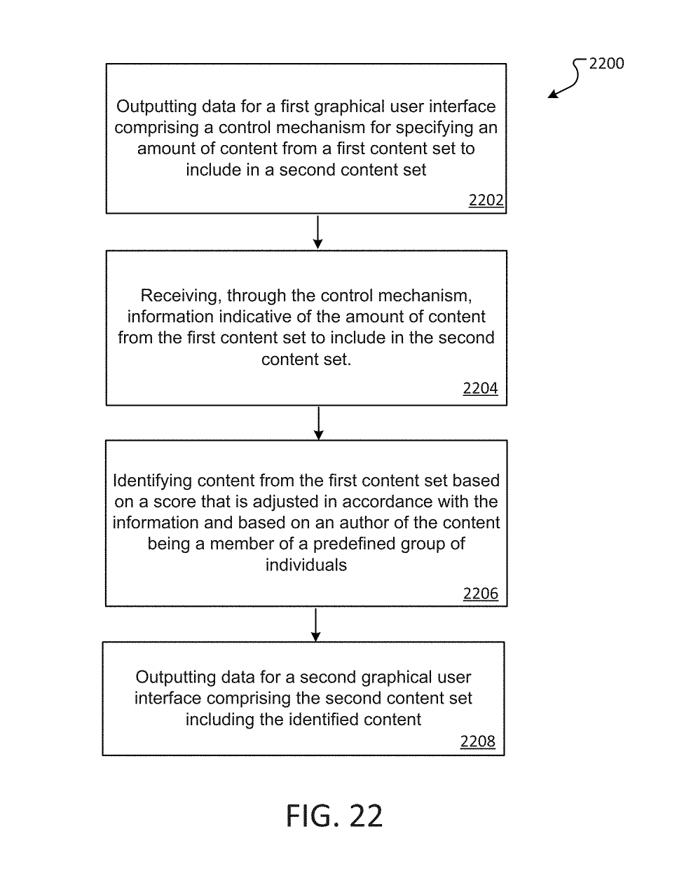

FIG. 22 is a flowchart 2200 of operations for a method for presenting content, e.g., in a user's main content stream in response to setting social circle control mechanisms. The operations may be executed by one or more computing devices that may be positioned at a single location or distributed across two or more locations and capable of using one or more communication techniques (e.g., connected to one or more networks). Operations may include, outputting 2202 data for a first graphical user interface comprising a control mechanism for specifying an amount of content from a first content set to include in a second content set. Operations may also include receiving 2204, through the control mechanism, information indicative of the amount of content from the first content set to include in the second content set. Operations may also include identifying 2206 content from the first content set based on a score that is adjusted in accordance with the information and based on an author of the content being a member of a predefined group of individuals. Operations may also include outputting 2208 data for a second graphical user interface comprising the second content set including the identified content.

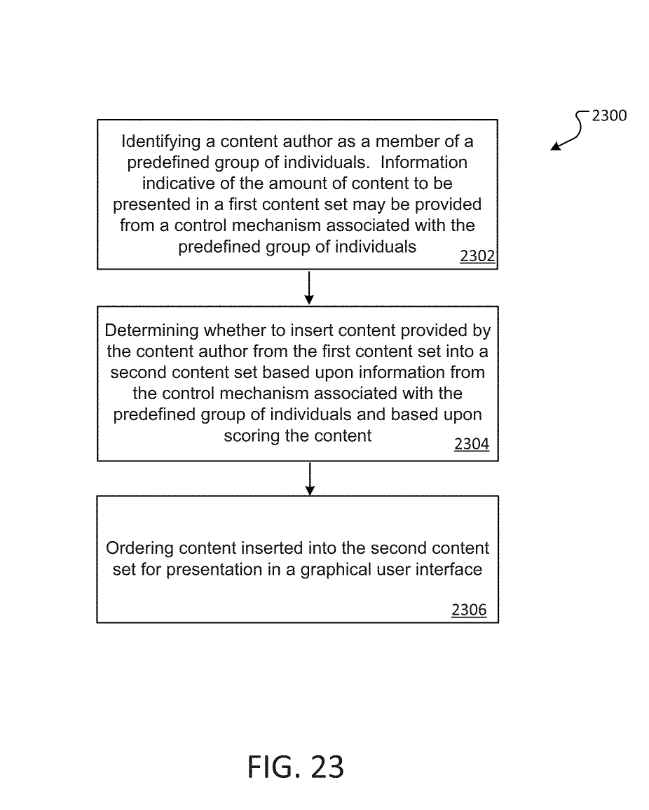

FIG. 23 is a flowchart 2300 of operations for a method for determining content to include, e.g., in a user's main content stream in response to setting social circle control mechanisms. The operations may be executed by one or more computing devices that may be positioned at a single location or distributed across two or more locations and capable of using one or more communication techniques (e.g., connected to one or more networks). Operations may include identifying 2302 a content author as a member of a predefined group of individuals. Information indicative of the amount of content to be presented in a first content set may be provided from a control mechanism associated with the predefined group of individuals. Operations may also include determining 2304 whether to insert content provided by the content author from the first content set into a second content set based upon information from the control mechanism associated with the predefined group of individuals and based upon scoring the content. Operations may also include ordering 2306 content inserted into the second content set for presentation in a graphical user interface.

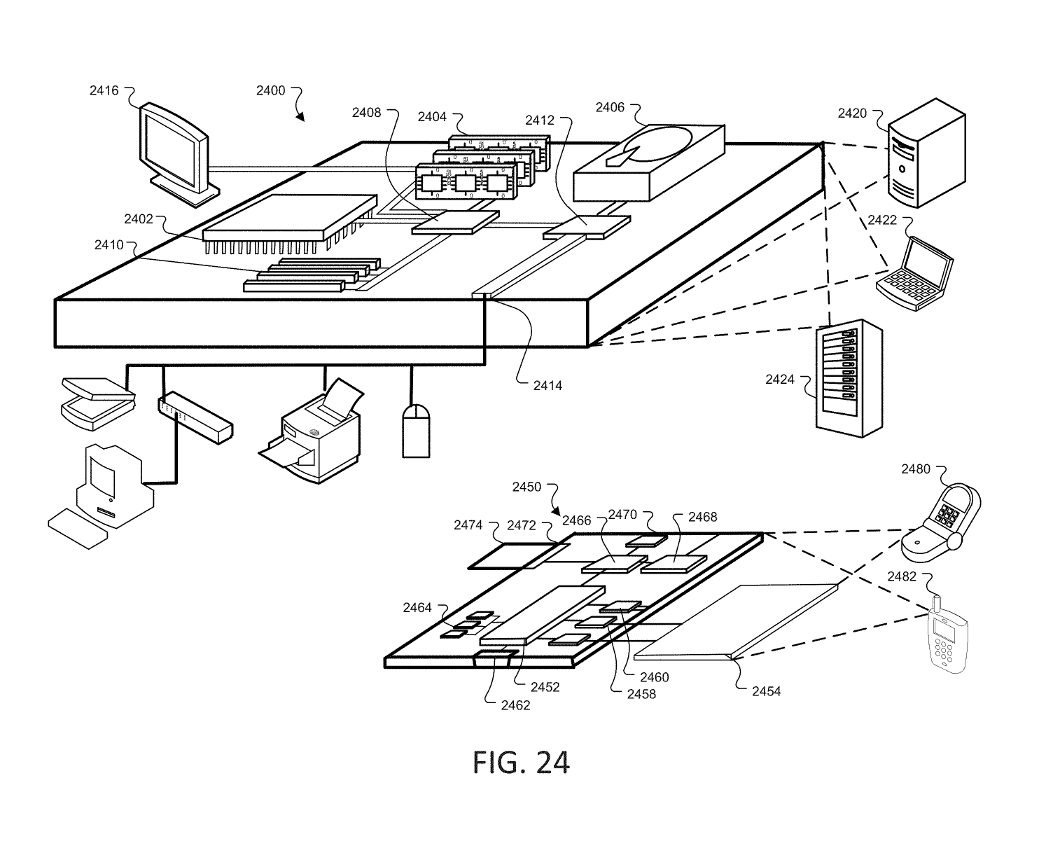

FIG. 24 shows examples of computing devices on which the processes described herein, or portions thereof, may be implemented. In this regard, FIG. 24 shows an example of a generic computing device 2400 and a generic mobile computing device 2450, which may be used to implement the processes described herein, or portions thereof. For example, a main content stream may be presented by processes executed on computing device 2400. Mobile computing device 2450 may represent a client device of FIG. 1. Other client devices of FIG. 1 may also have the architecture of computing device 2400.

Computing device 2400 is intended to represent various forms of digital computers, examples of which include laptops, desktops, workstations, personal digital assistants, servers, blade servers, mainframes, and other appropriate computers. Computing device 2450 is intended to represent various forms of mobile devices, examples of which include personal digital assistants, cellular telephones, smartphones, and other similar computing devices. The components shown here, their connections and relationships, and their functions, are meant to be exemplary only, and are not meant to limit implementations of the implementations described and/or claimed in this document.

Computing device 2400 includes a processor 2402, memory 2404, a storage device 2406, a high-speed interface 2408 connecting to memory 2404 and high-speed expansion ports 2410, and a low speed interface 2412 connecting to low speed bus 2414 and storage device 2406. Components 2402, 2404, 2406, 2408, 2410, and 2412, are interconnected using various busses, and may be mounted on a common motherboard or in other manners as appropriate. The processor 2402 may process instructions for execution within the computing device 2400, including instructions stored in the memory 2404 or on the storage device 2406 to display graphical information for a GUI on an external input/output device, for example, display 2416 coupled to high speed interface 2408. In other implementations, multiple processors and/or multiple buses may be used, as appropriate, along with multiple memories and types of memory. Also, multiple computing devices 2400 may be connected, with a device providing a portion of the necessary operations (e.g., as a server bank, a group of blade servers, or a multi-processor system).

The memory 2404 stores information within the computing device 2400. In one implementation, the memory 2404 is a volatile memory unit or units. In another implementation, the memory 2404 is a non-volatile memory unit or units. The memory 2404 may also be another form of computer-readable medium, examples of which include a magnetic or optical disk.

The storage device 2406 is capable of providing mass storage for the computing device 2400. In one implementation, the storage device 2406 may be or contain a computer-readable medium, examples of which include a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, including those described above. The information carrier may be a non-transitory computer- or machine-readable medium, for example, the memory 2404, the storage device 2406, or memory on processor 2402. For example, the information carrier may be a non-transitory, machine-readable storage medium.

The high speed controller 2408 manages bandwidth-intensive operations for the computing device 2400, while the low speed controller 2412 manages lower bandwidth-intensive operations. Such allocation of functions is exemplary only. In one implementation, the high-speed controller 2408 is coupled to memory 2404, display 2416 (e.g., through a graphics processor or accelerator), and to high-speed expansion ports 2410, which may accept various expansion cards (not shown). In the implementation, low-speed controller 2412 is coupled to storage device 2406 and low-speed expansion port 2414. The low-speed expansion port, which may include various communication ports (e.g., USB, Bluetooth, Ethernet, wireless Ethernet) may be coupled to one or more input/output devices, e.g., a keyboard, a pointing device, a scanner, or a networking device, e.g., a switch or router, e.g., through a network adapter.

The computing device 2400 may be implemented in a number of different forms, as shown in the figure. For example, it may be implemented as a standard server 2420, or multiple times in a group of such servers. It may also be implemented as part of a rack server system 2424. In addition, it may be implemented in a personal computer, e.g., a laptop computer 2422. Alternatively, components from computing device 2400 may be combined with other components in a mobile device (not shown), e.g., device 2450. Such devices may contain one or more of computing device 2400, 2450, and an entire system may be made up of multiple computing devices 2400, 2450 communicating with one other.

Computing device 2450 includes a processor 2452, memory 2464, an input/output device, e.g. a display 2454, a communication interface 2466, and a transceiver 2468, among other components. The device 2450 may also be provided with a storage device, e.g., a microdrive or other device, to provide additional storage. The components 2450, 2452, 2464, 2454, 2466, and 2468, are interconnected using various buses, and several of the components may be mounted on a common motherboard or in other manners as appropriate.

The processor 2452 may execute instructions within the computing device 2450, including instructions stored in the memory 2464. The processor may be implemented as a chipset of chips that include separate and multiple analog and digital processors. The processor may provide, for example, for coordination of the other components of the device 2450, e.g., control of user interfaces, applications run by device 2450, and wireless communication by device 2450.

Processor 2452 may communicate with a user through control interface 2458 and display interface 2456 coupled to a display 2454. The display 2254 may be, for example, a TFT LCD (Thin-Film-Transistor Liquid Crystal Display) or an OLED (Organic Light Emitting Diode) display, or other appropriate display technology. The display interface 2456 may include appropriate circuitry for driving the display 2454 to present graphical and other information to a user. The control interface 2458 may receive commands from a user and convert them for submission to the processor 2452. In addition, an external interface 2462 may be provide in communication with processor 2452, so as to enable near area communication of device 2450 with other devices. External interface 2462 may provide, for example, for wired communication in some implementations, or for wireless communication in other implementations, and multiple interfaces may also be used.

The memory 2464 stores information within the computing device 2450. The memory 2464 may be implemented as one or more of a computer-readable medium or media, a volatile memory unit or units, or a non-volatile memory unit or units. Expansion memory 2474 may also be provided and connected to device 2450 through expansion interface 2472, which may include, for example, a SIMM (Single In Line Memory Module) card interface. Such expansion memory 2474 may provide extra storage space for device 2450, or may also store applications or other information for device 2450. Specifically, expansion memory 2474 may include instructions to carry out or supplement the processes described above, and may include secure information also. Thus, for example, expansion memory 2474 may be provide as a security module for device 2450, and may be programmed with instructions that permit secure use of device 2450. In addition, secure applications may be provided by the SIMM cards, along with additional information, e.g., placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, including those described above. The information carrier is a computer- or machine-readable medium, e.g., the memory 2464, expansion memory 2474, memory on processor 2452, or a propagated signal that may be received, for example, over transceiver 2468 or external interface 2462.

Device 2450 may communicate wirelessly through communication interface 2466, which may include digital signal processing circuitry where necessary. Communication interface 2466 may provide for communications under various modes or protocols, examples of which include GSM voice calls, SMS, EMS, or MMS messaging, CDMA, TDMA, PDC, WCDMA, CDMA2000, or GPRS, among others. Such communication may occur, for example, through radio-frequency transceiver 2468. In addition, short-range communication may occur, e.g., using a Bluetooth, Wi-Fi, or other such transceiver (not shown). In addition, GPS (Global Positioning System) receiver module 2470 may provide additional navigation- and location-related wireless data to device 2450, which may be used as appropriate by applications running on device 2450.

Device 2450 may also communicate audibly using audio codec 2460, which may receive spoken information from a user and convert it to usable digital information. Audio codec 2460 may likewise generate audible sound for a user, e.g., through a speaker, e.g., in a handset of device 2450. Such sound may include sound from voice telephone calls, may include recorded sound (e.g., voice electronic messages, music files, etc.) and may also include sound generated by applications operating on device 2450.

The computing device 2450 may be implemented in a number of different forms, as shown in the figure. For example, it may be implemented as a cellular telephone 2480. It may also be implemented as part of a smartphone 2482, personal digital assistant, or other similar mobile device.

Various implementations of the systems and techniques described here may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to a signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be a form of sensory feedback (e.g., visual feedback, auditory feedback, or tactile feedback); and input from the user may be received in a form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or a combination of such back end, middleware, or front end components. The components of the system may be interconnected by a form or medium of digital data communication (e.g., a communication network). Examples of communication networks include a local area network (“LAN”), a wide area network (“WAN”), and the Internet.

The computing system may include clients and servers. A client and server are generally remote from one other and typically interact through a communication network. The relationship of client and server arises by virtue of computer programs running on the respective computers and having a client-server relationship to one other.

In some implementations, the engines described herein may be separated, combined or incorporated into a single or combined engine. The engines depicted in the figures are not intended to limit the systems described here to the software architectures shown in the figures.

For situations in which the systems and techniques discussed herein collect personal information about users, the users may be provided with an opportunity to enable/not enable of programs or features that may collect personal information (e.g., information about a user's preferences or a user's current location). In addition, certain data may be anonymized in one or more ways before it is stored or used, so that personally identifiable information is removed. For example, a user's identity may be anonymized so that no personally identifiable information may be determined for the user , or a user's geographic location may be generalized where location information is obtained (e.g., to a city, zip code, or state level), so that a particular location of the user cannot be determined.

Although implementations are discussed primarily in the context of digital content generated and distributed in the form of electronic messages, implementations are applicable to other content types including, for example, chat content, social networking posts, content posted to sharing services (e.g., photo sharing services), content posted to a blogging services, and so forth.

Although implementations are discussed primarily in the context of presenting user-generated content from members of the searcher's social graph, user-generated content from parties who are not members of the searcher's social graph may also be presented. For example, if a user is searching for a particular topic, if available and appropriate permissions have been obtained, user-generated content from experts on that topic may be presented, even if those experts are not part of the searcher's social graph.

Elements of different implementations described herein may be combined to form other implementations not specifically set forth above. Elements may be left out of the processes, computer programs, Web pages, etc. described herein without adversely affecting their operation. In addition, the logic flows depicted in the figures do not require the particular order shown, or sequential order, to achieve desirable results. Various separate elements may be combined into one or more individual elements to perform the functions described herein.

The features described herein may be combined in a single system, or used separately in one or more systems.

Other implementations not specifically described herein are also within the scope of the following claims.

What is claimed is:

1. A method comprising:
in one or more processing devices, executing instructions to perform operations comprising:
outputting data for a first graphical user interface comprising a first control mechanism and a second control mechanism for specifying amounts of content items from a first content set to include in a second content set, the first content set comprising content items authored by members of social groups of a social network, a member belonging to a first one of the social groups and a second one of the social groups;
receiving, through the first control mechanism, data indicative of a first setting for the first one of the social groups that includes the member, the first setting indicative of a first amount of content items that are from the first content set, that are authored by the member, and that are candidates to include in the second content set;
receiving, through the second control mechanism, data indicative of a second setting for the second one of the social groups that includes the same member, the second setting indicative of a second amount of the content items that are from the first content set, that are authored by the same member, and that are candidates to include in the same second content set, wherein the first amount differs from the second amount, and wherein a conflict is defined by a difference between the first amount and the second amount;
associating the content items that are from the first content set and that are authored by the member with one or more time periods indicative of when the content items are added to the first content set, wherein the first and second amounts are each associated with a particular time period of the one or more time periods;
determining a frequency of access by a client device of the second content set specified by the first and second control mechanisms for specifying amounts of content items from the first content set to include in the second content set;
selecting content items from the first content set comprising the content items authored by the members of social groups of the social network for inclusion in the second content set specified by the first and second control mechanisms for specifying amounts of content items from the first content set to include in the second content set by:
resolving the conflict between (i) the first amount of content items authored by the member from the first content set that are candidates for inclusion in the second content set, and (ii) the second, different amount of content items authored by the same member from the same first content set that are candidates for inclusion in the same second content set by application of one or more rules specifying a third amount of the content items that are from the first content set, that are authored by the member, and that are selected to include in the second content set, and with the resolving further based on the particular time period, wherein the third amount is a function of the first amount or the second amount; and
adjusting the third amount of the content items that are selected based on the determined frequency of access of the second content set by the client device; and
outputting data for a second graphical user interface comprising the second content set including the selected content items.

2. The method of claim 1, wherein a control mechanism of each of the first and second control mechanisms comprises a respective slider, the respective sliders being controllable to move between locations corresponding to different amounts of content from the first content set;
wherein a score associated with each of the first setting and the second setting is respectively adjusted in accordance with a value that is based on a location of the respective slider.

3. The method of claim 1, wherein a control mechanism of the first and second control mechanisms comprises radio buttons, the radio buttons being selectable to correspond to different amounts of content from the first content set;
wherein a score associated with each of the first setting and the second setting is respectively adjusted in accordance with a value that is based on which of the radio buttons is selected.

4. The method of claim 1, wherein a control mechanism of the first and second control mechanisms comprises a drop-down menu, elements of the drop-down menu being selectable to correspond to different amounts of content from the first content set;
wherein a score associated with each of the first setting and the second setting is respectively adjusted in accordance with a value that is based on which element of the drop-down menu is selected.

5. The method of claim 1, wherein the first content set comprises a first content stream and the second content set comprises a second content stream, the first content stream comprising content from a first source type and the second content stream comprising content from different source types.

6. The method of claim 5, wherein the first source type comprises a group of social contacts and the second source type comprises two or more groups of contacts, the two or more groups of contacts comprising the group of social contacts.

7. The method of claim 5, wherein the first source type comprises a contact and the second source type comprises two or more contacts, the two or more contacts comprising the contact.

8. The method of claim 1, wherein the first content set comprises at least one of: saved searches and posts, and the second content set comprises a content stream of a social networking service.

9. The method of claim 1, wherein a control mechanism of the first and second control mechanisms is configured to specify an amount of content from one or more additional content sets to include in the second content set, the one or more additional content sets being different from the first content set.

10. The method of claim 1, wherein a control mechanism of the first and second control mechanisms specifies an amount of content from the first content set by enabling input regarding an affinity for, or interest in content from, an entity associated with the first content set.

11. The method of claim 1, wherein at least a portion of the first content set is provided by an author that is a member of a predefined group of individuals.

12. The method of claim 1, wherein the first content set includes publicly available content.

13. A method comprising:
in one or more processing devices, executing instructions to perform operations comprising:
identifying a content author as a member of one or more social groups, wherein data indicative of settings indicative of one or more amounts of content items authored by the content author to be included from a first content set into a second content set are specified by a first setting of a first control mechanism associated with the one or more social groups and by a second setting of a second control mechanism associated with the one or more social groups, the first setting specifying a first amount of content items authored by the content author from the first content set to include in the second content set, and the second setting specifying a second amount of content items authored by the content author from the first content set to include in the second content set, wherein the first amount differs from the second amount, and wherein a conflict is defined by a difference between the first amount and the second amount;
associating each of the content items authored by the content author with respective time periods indicative of when each of the content items are being added to the first content set;
determining a frequency of access by a client device of the second content set specified by the first setting of the first control mechanism and by the second setting of the second control mechanism;
selecting content items authored by the content author from the first content set to include into a second content set, with the determining based upon scoring the content items, the respective time periods associated with each of the content items, the frequency of access of the second content set by the client device, and one or more rules that resolve the conflict between the first amount and the second, different amount, the one or more rules specifying a third amount of the content items authored by the content author that are selected to include in the second content set based on the first amount and the second amount; and
ordering the selected content items included in the second content set, for presentation in a graphical user interface.

14. The method of claim 13, wherein determining whether to include content items authored by the content author includes ranking the content items.

15. The method of claim 13, wherein determining whether to include content items authored by the content author includes discarding the content items based upon the settings received through the first and second control mechanisms associated with the one or more social groups.

16. The method of claim 13, wherein determining whether to include content items authored by the content author includes inserting the content items based upon the settings received through the first and second control mechanisms associated with the one or more social groups.

17. The method of claim 13, wherein determining whether to include content items authored by the content author includes grouping the content items with other content items received within a predefined time period.

18. The method of claim 17, wherein the grouped content items are scored and ranked to identify the content items to be included into the second content set for presentation in the graphical user interface.

19. The method of claim 18, wherein scores assigned to other content items authored by the content author are modified if the content items from the author are inserted into the second content set for presentation in the graphical user interface.

20. The method of claim 17, wherein the predefined time period is twenty-four hours.

21. The method of claim 13, wherein determining whether to include content items authored by the content author from the first content set into the second content set is based upon a predefined limit of content entries assigned to the content author.

22. The method of claim 13, further comprising:
retaining previously read content entries in the second content set.

23. The method of claim 13, wherein determining whether to include content items authored by the content author from the first content set into the second content set is based upon a frequency of which the second content set is viewed in the graphical user interface.

24. The method of claim 18, wherein scores assigned to other content items from a group that includes the content author are modified if the content items from the author are inserted into the second content set for presentation in the graphical user interface.

25. A system comprising:
memory to store instructions that are executable; and
one or more processing devices to execute the instructions to perform operations comprising:
identifying a content author as a member of one or more social groups, wherein data indicative of settings indicative of one or more amounts of content items authored by the content author to be included from a first content set into a second content set are specified by a first setting of a first control mechanism associated with the one or more social groups and by a second setting of a second control mechanism associated with the one or more social groups, the first setting specifying a first amount of content items authored by the content author from the first content set to include in the second content set, and the second setting specifying a second amount of content items authored by the content author from the first content set to include in the second content set, wherein the first amount differs from the second amount, and wherein a conflict is defined by a difference between the first amount and the second amount;
associating each of the content items authored by the content author with respective time periods indicative of when each of the content items are being added to the first content set;
determining a frequency of access by a client device of the second content set specified by the first setting of the first control mechanism and by the second setting of the second control mechanism;
selecting content items authored by the content author from the first content set to include into a second content set, with the determining based upon scoring the content items, the respective time periods associated with each of the content items, the frequency of access of the second content set by the client device, and one or more rules that resolve the conflict between the first amount and the second, different amount, the one or more rules specifying a third amount of the content items authored by the content author that are selected to include in the second content set based on the first amount and the second amount; and
ordering the selected content items included in the second content set, for presentation in a graphical user interface.

26. The method of claim 1, wherein the third amount, specified by the one or more rules, is different than the first amount indicated by the first setting and is different than the second amount indicated by the second setting.
